(19) United States
(12) Patent Application Publication
(10) Pub. No.: US 2026/0205568 A1
(43) Pub. Date: Jul. 16, 2026

(54) GLASSES-FREE AR DISPLAY DEVICE

(71) Applicant: NTT, Inc., Tokyo (JP)

(72) Inventors: Kenta OGO, Musashino-shi (JP); Shingo KINOSHITA, Musashino-shi (JP); Takahiro MATSUMOTO, Musashino-shi (JP); Munekazu DATE, Musashino-shi (JP); Motohiro MAKIGUCHI, Musashino-shi (JP); Hiroshi CHIGIRA, Musashino-shi (JP); Takayoshi MOCHIZUKI, Musashino-shi (JP)

(73) Assignee: NTT, Inc., Tokyo (JP)

(21) Appl. No.: 19/130,557

(22) PCT Filed: Nov. 16, 2022
(86) PCT No.: PCT/JP2022/042609

§ 371 Date: May 16, 2025

(51) Int. Cl. H04N 13/302; G02B 1/11; G02B 27/01; H04N 7/15

(52) U.S. Cl. CPC H04N 13/302; G02B 1/11; G02B 27/0101; G02B 27/0149; H04N 7/15; G02B 2027/0138; G02B 2027/0159; G02B 2027/0169

(57) ABSTRACT

A glasses-free AR display device includes a half mirror, a darkroom-like structure, a display, an illumination, and a video controller. The half mirror is disposed upright on a floor. The darkroom-like structure is provided behind the half mirror. The display is disposed in the darkroom-like structure obliquely to a surface of the half mirror. The illumination illuminates a user located in front of the half mirror on the opposite side of the display. The video controller receives a video signal and causes the display to display a video.

### TECHNICAL FIELD

The present invention relates to a glasses-free Augmented Reality (AR) display device.

### BACKGROUND ART

A glasses-free AR display device is a device that displays a world of augmented reality without using a tool such as glasses. As one of technologies using the glasses-free AR display device, for example, there is a technology called a mirror type video conference in which a user on-site and a conversation partner at a remote place are combined and displayed on a display, such as a space sharing system for realizing telepresence. For example, PTL 1 discloses an example of the mirror type video conference.

In the mirror type video conference, the user and the conversation partner are synthesized and displayed on a display viewed as a mirror by the naked eye of the user. It is known that, in the mirror type video conference, a situation of conversation with the partner is reproduced in front of the eyes, thereby enhancing a feeling of being adjacent to the partner and in the same space.

Further, in recent years, there has been proposed a glasses-free AR display technology for combining and displaying a video (a user or the like) of a real world and various types of digital information (an avatar or the like) of a virtual world.

### CITATION LIST

### Patent Literature

[PTL 1] Japanese Patent Application Publication No. 2015-154430

### SUMMARY OF INVENTION

### Technical Problem

In the future, it is expected that a glasses-free AR display device will be required to achieve a higher quality AR display (such as reproducing a spatial spread feeling and a depth feeling to enhance a feeling of the same room).

The present invention has been made by paying attention to such a request, and an object of the present invention is to provide a glasses-free AR display device that achieves a higher quality AR display.

### Solution to Problem

An aspect of the present invention is a glasses-free AR display device. The glasses-free AR display device includes a half mirror, a darkroom-like structure, a display, an illumination, and a video controller. The half mirror is disposed upright on a floor. The darkroom-like structure is provided behind the half mirror. The display is disposed in the darkroom-like structure obliquely to a surface of the half mirror. The illumination illuminates a user located in front of the half mirror on the opposite side of the display. The video controller receives a video signal and causes the display to display a video.

### Advantageous Effects of Invention

According to the present invention, a glasses-free AR screen display device capable of providing a user with an excellent 3D spatial sensation is provided.

### BRIEF DESCRIPTION OF DRAWINGS

FIG. 1 is a perspective view schematically illustrating a configuration of a glasses-free AR display device according to an embodiment.

FIG. 2 is a plan view of the glasses-free AR display device illustrated in FIG. 1 viewed from above.

FIG. 3 is a configuration diagram of a space sharing system of an example of a joining between a real space and a real space using the glasses-free AR display device illustrated in FIGS. 1 and 2.

FIG. 4 is a configuration diagram of a space sharing system of an example of a joint between a real space and a virtual space using the glasses-free AR display device illustrated in FIGS. 1 and 2.

FIG. 5 is a perspective view illustrating a state of use of the glasses-free AR display device shown in FIGS. 1 and 2.

FIG. 6 is a diagram illustrating a state in which a double image of a video displayed on a display is seen.

FIG. 7 is a diagram illustrating a person position sensor and a rotation mechanism.

FIG. 8 is a diagram illustrating a state in which a double image of a video displayed on a display is not seen.

FIG. 9 is a diagram illustrating a state in which a video displayed on the display is floated.

FIG. 10 is a diagram illustrating a state in which furniture is prepared as a “joint” and a sense of unity is produced by a common animation operation.

FIG. 11 is a plan view illustrating a state in which a desk is placed between the half mirror and the display.

FIG. 12 is a perspective view illustrating a state in which the glasses-free AR display device illustrated in FIG. 11 is viewed from the user side.

FIG. 13 is a perspective view of a glasses-free AR display device having a sub-display for an emote effect.

FIG. 14 is a plan view of the glasses-free AR display device illustrated in FIG. 13 viewed from above.

FIG. 15 is a diagram illustrating a state in which a video in which the user and the conversation partner are arranged becomes flat.

FIG. 16 is a diagram illustrating a glasses-free AR display device provided with additional displays.

FIG. 17 is a perspective view illustrating a state in which a desk is placed in front of the half mirror.

FIG. 18 is a plan view illustrating a state in which objects are placed in plane symmetry with respect to the half mirror and a display is placed behind a sofa.

FIG. 19 is a perspective view illustrating a state in which a glasses-free AR display device in which objects and a display are placed as illustrated in FIG. 18 is viewed from the user side.

FIG. 20 is a perspective view schematically illustrating a state in which a real person sits on a sofa.

FIG. 21 is a perspective view illustrating a state in which a glasses-free AR display device in which desks are placed as illustrated in FIG. 11 is viewed from the user side.

FIG. 22 is a diagram schematically showing a state in which the video of the conversation partner is seen through when a background behind the user is bright.

FIG. 23 is a perspective view illustrating a state of a glasses-free AR display device in which a screen is placed at a position plane-symmetrical with the display with respect to a surface of the half mirror is viewed from above the user.

FIG. 24 is a perspective view illustrating a state in which a glasses-free AR display device in which two dark high-back chairs are placed on the user side with respect to the half mirror is viewed from above.

FIG. 25 is a plan view illustrating a positional relationship between the display, the high-back chair, and the camera with respect to the half mirror in the glasses-free AR display device illustrated in FIG. 24.

FIG. 26 is a perspective view illustrating a state in which a wide shadow is added to a back video reflected on the half mirror.

FIG. 27 is a diagram illustrating an operator who wears a head-mounted display (HMD) and operates an avatar using a hand controller.

FIG. 28 is a perspective view schematically showing a part of the virtual glasses-free AR display device illustrated in FIG. 4.

FIG. 29 is a diagram illustrating a state in which a video of the conversation partner is seen through when a video of the user overlaps the video of the conversation partner.

FIG. 30 is a perspective view illustrating a state in which a glasses-free AR display device in which a robot is disposed next to a user is viewed from the user side.

FIG. 31 is a block diagram illustrating a control system for controlling an operation of the robot.

FIG. 32 is a perspective view illustrating a state in which a glasses-free AR display device in which a torso-type cushion is disposed next to the user is viewed from the user side.

FIG. 33 is a diagram illustrating an example in which a fusion space between an on-site (local) side and a remote side is created using the glasses-free AR display device according to the embodiment.

FIG. 34 is a diagram illustrating an example of creating a fusion space of a real world and a cyber world by using the glasses-free AR display device according to the embodiment.

FIG. 35 is a diagram illustrating an example of a system in which a real world (set construction) and a virtual world (in-world) are joined as a pair by using the glasses-free AR display device according to the embodiment.

FIG. 36 is a diagram illustrating an example of creating a fusion space between a real world and a metaverse using the glasses-free AR display device according to the embodiment.

FIG. 37 is a diagram illustrating an example of a system in which a real world (set construction) and a virtual world (in-world) are joined as a pair by using the glasses-free AR display device according to the embodiment.

### DESCRIPTION OF EMBODIMENTS

Hereinafter, embodiments according to the present invention will be described with reference to the drawings.

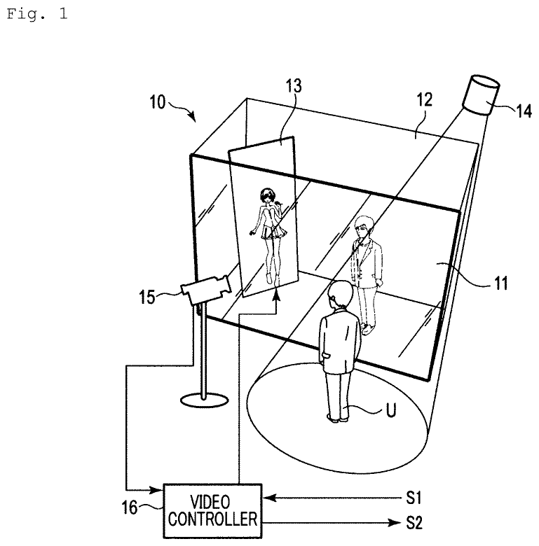

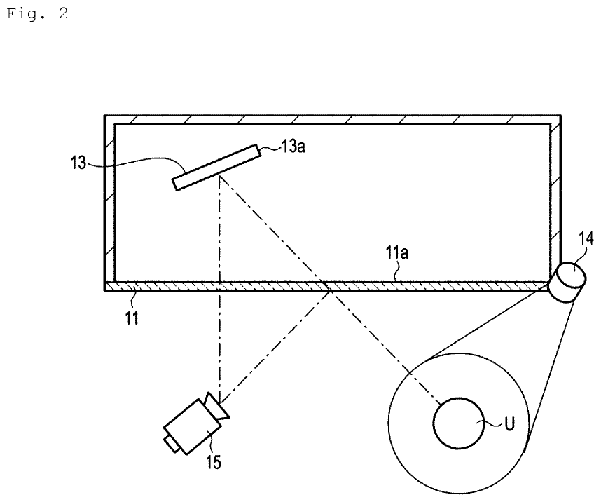

A glasses-free AR display device according to the present embodiment will be described with reference to FIGS. 1 and 2.

FIG. 1 is a perspective view schematically illustrating a configuration of a glasses-free AR display device 10 according to an embodiment. FIG. 2 is a plan view of the glasses-free AR display device 10 illustrated in FIG. 1 viewed from above.

Here, an example in which the glasses-free AR display device is applied to the mirror type video conference will be described.

The glasses-free AR display device 10 includes the half mirror 11, a darkroom-like structure 12, the display 13, an illumination 14, the camera 15, and the video controller 16.

The half mirror 11 is disposed upright on a floor.

The darkroom-like structure 12 is provided behind the half mirror 11.

The display 13 is disposed at a corner in the darkroom-like structure 12 obliquely to a surface of the half mirror 11. The display 13 has a size allowing a person to be displayed in life size. The display 13 is not limited to this, but may be a large LED display, for example.

When the glasses-free AR display device 10 is used, the user U is located in front of the half mirror 11 and faces the display 13. That is, the user U is located in front of the half mirror 11 on the opposite side of the display 13, and views the video displayed on the display 13 through the half mirror 11 with a line of sight facing the display 13. The illumination 14 illuminates the user U. Thus, an image of the user U is projected onto the half mirror 11.

The camera 15 is installed at a position plane-symmetrical to the display 13 with respect to the surface of the half mirror 11. The camera 15 captures the user U reflected on the half mirror 11. That is, the camera 15 is disposed toward an intersection between a straight line connecting the display 13 and the user U and a front surface of the half mirror 11.

The video controller 16 has a function of receiving the video signal S 1 and displaying a video on the display 13, and a function of acquiring a captured video of the camera 15 and transmitting a video signal S2.

The camera 15 captures the user U reflected on the surface of the half mirror 11. Therefore, the image of the user U is inverted in right and left directions in the video captured by the camera 15.

The video controller 16 performs image processing for horizontally inverting the image of the user U. Basically, the image of the user U may be captured in a place where a background is black. A part in which the background is not black is separated by a technology for cutting out an existing person. When the cutting-out is unnecessary, the image may be sent as it is. The video controller 16 transmits a video after image processing as the video signal S2.

The video signal includes both a moving image signal and an audio signal. That is, the video captured by the camera 15 includes both a moving image and an audio. Further, the display 13 has a function of reproducing both the moving image signal and the audio signal.

The video displayed on the display 13 is the person or the avatar. The camera 15 is preferably disposed at a height of the eyes of the person or the avatar.

### Example of Joining between Real Space and Real Space

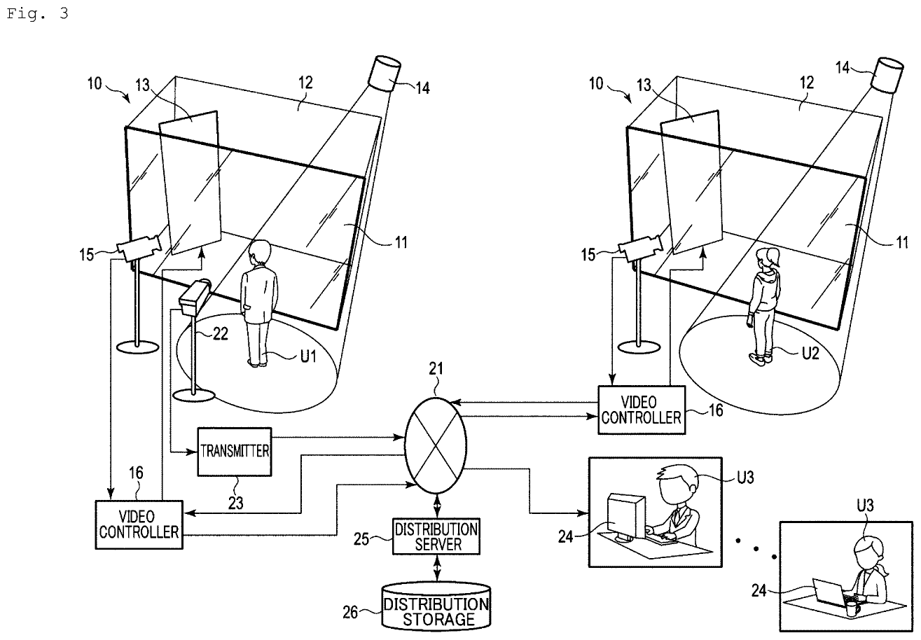

Next, a space sharing system of an example of joining between the real space and the real space using the glasses-free AR display device 10 illustrated in FIGS. 1 and 2 will be described with reference to FIG. 3. FIG. 3 is a configuration diagram of a space sharing system of an example of a joint between a real space and a real space using the glasses-free AR display device illustrated in FIGS. 1 and 2.

The space sharing system includes two glasses-free AR display devices 10. A configuration of each glasses-free AR display device 10 is as described with reference to FIGS. 1 and 2.

In the two glasses-free AR display devices 10, video controllers 16 may be connected to each other via a transmission network 21. Thus, the two glasses-free AR display devices 10 can transmit and receive video signals to and from each other. In the two glasses-free AR display devices 10, video controllers 16 may be connected to each other via a transmission line instead of the transmission network 21.

A user U1 using the left glasses-free AR display device 10 is reflected on the half mirror 11 of the left glasses-free AR display device 10. On the other hand, the user U2 using the right glasses-free AR display device 10 is reflected on the half mirror 11 of the right glasses-free AR display device 10.

A video of the user U1 reflected on the half mirror 11 captured by the camera 15 of the left glasses-free AR display device 10 is displayed on the display 13 of the right glasses-free AR display device 10. On the other hand, a video of the user U2 reflected on the half mirror 11 captured by the camera 15 of the right glasses-free AR display device 10 is displayed on the display 13 of the left glasses-free AR display device 10.

Thus, the user U1 using the left glasses-free AR display device 10 can view an own video (mirror image) reflected on the half mirror 11 of the left glasses-free AR display device 10 and the video of the user U2 displayed on the display 13 of the left glasses-free AR display device 10. Similarly, the user U2 using the right glasses-free AR display device 10 can view an own video (mirror image) reflected on the half mirror 11 of the right glasses-free AR display device 10 and the video of the user U1 displayed on the display 13 of the right glasses-free AR display device 10.

For example, since the user U1 looks at the video of the user U2 displayed on the display 13 next to the video (mirror image) of the user himself/herself reflected on the half mirror 11, the user U1 can converse with the user U2 that is a conversation partner as if next to the user U2 in the same room. That is, the user U1 can enjoy the feeling of conversation with the adjacent user U2 in a pseudo manner. The same applies to the user U2.

The space sharing system further includes a distribution camera 22 and a transmitter 23.

The distribution camera 22 is disposed in front of the half mirror 11 of the glasses-free AR display device 10 on the left side. For example, the distribution camera 22 is disposed directly in front of the center of the half mirror 11 of the left glasses-free AR display device 10. The distribution camera 22 can capture the user U1 reflected on the half mirror 11 and the user U2 displayed on the display 13 without being blocked by the user U1, unlike a face-to-face type device. That is, the distribution camera 22 can capture the user U1 and the user U2 at a third person viewpoint. Further, the distribution camera 22 may be disposed at the position plane-symmetrical with respect to the half mirror 11.

The transmitter 23 transmits a video signal for distribution captured by the distribution camera 22 to the transmission network 21. The video signal for distribution is received by a reception device 24 (for example, a computer) included in a plurality of users U3, and the videos of the users U1 and U2 are reproduced. Thus, each user U3 can view the videos of the user U1 and the user U2 in real time.

The space sharing system further includes a distribution server 25 and a distribution storage 26. The distribution server 25 stores the video to be live-distributed in the distribution storage 26. The distribution server 25 also reads the video from the distribution storage 26 in response to a viewing request from the user U3, and transmits a video signal to the reception device 24 of the user U 3 requesting viewing. Thus, the user U3 can archive and view the videos of the user U1 and the user U2.

### Example of Joining between Real Space and Virtual Space

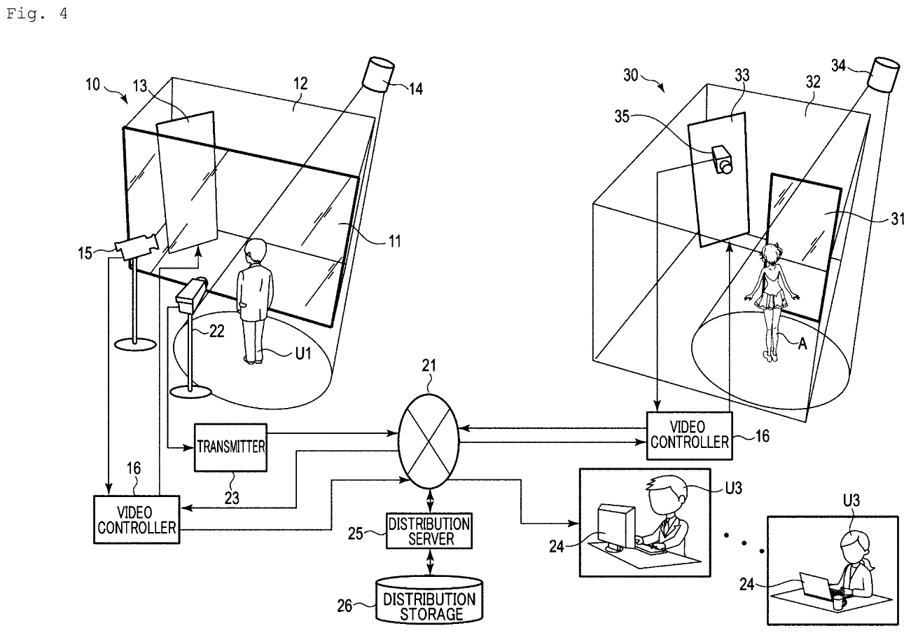

Next, a space sharing system of an example of a joint between a real space and a virtual space using the glasses-free AR display device 10 illustrated in FIGS. 1 and 2 will be described with reference to FIG. 4. FIG. 4 is a configuration diagram of a space sharing system of an example of a joint between a real space and a virtual space using the glasses-free AR display device illustrated in FIGS. 1 and 2.

The space sharing system includes one glasses-free AR display device 10 and one virtual glasses-free AR display device 30. A configuration of the glasses-free AR display device 10 is as described with reference to FIGS. 1 and 2. The virtual glasses-free AR display device 30 is a device created in a virtual space similar to the glasses-free AR display device 10. The virtual glasses-free AR display device 30 has a function substantially similar to that of the glasses-free AR display device 10. A participant in the virtual glasses-free AR display device 30 corresponding to the user U1 of the glasses-free AR display device 10 is an avatar A. The avatar A is operated by a user (not shown).

The virtual glasses-free AR display device 30 includes a virtual mirror 31, a darkroom-like virtual structure 32, a virtual display 33, a virtual illumination 34, a virtual camera 35, and a video controller 36. The virtual mirror 31, the darkroom-like virtual structure 32, the virtual display 33, the virtual illumination 34, and the virtual camera 35 are disposed in a virtual space. The virtual mirror 31, the virtual display 33, the virtual illumination 34, and the virtual camera 35 are disposed in the darkroom-like virtual structure 32.

The virtual mirror 31 is disposed upright on a floor of the darkroom-like virtual structure 32. The virtual mirror 31 completely reflects light incident from one side and completely transmits light incident from the other side. The virtual mirror 31 is disposed so that the side of completely transmitting the incident light faces the back side of the darkroom-like virtual structure 32.

The virtual display 33 is disposed on the surface side of the virtual mirror 31 which completely transmits the incident light. Further, the virtual display 33 is disposed obliquely to the surface of the virtual mirror 31 at the back of the darkroom-like virtual structure 32.

The avatar A is located on the surface side of the virtual mirror 31 that completely reflects the incident light when the virtual glasses-free AR display device 30 is used. Further, the avatar A is located in front of the virtual mirror 31 and faces the virtual display 33. The virtual mirror 31 is installed not to disturb a visual field of the avatar A viewing the virtual display 33. Thus, the avatar A can view the video that is displayed on the virtual display 33 without any hindrance. The virtual illumination 34 illuminates the avatar A. Thus, the image of the avatar A is projected onto the virtual mirror 31.

The virtual camera 35 is disposed in front of the virtual display 33. That is, the virtual camera 35 is disposed on the surface side of the virtual mirror 31 which completely transmits the incident light. Further, the virtual camera 35 is disposed toward the avatar A using the virtual glasses-free AR display device 30. The virtual camera 35 captures the avatar A through the virtual mirror 31. Since the virtual mirror 31 is completely transparent from the side of the virtual camera 35, the virtual camera 35 captures the avatar A without any hindrance.

The video controller 36 has a function of receiving the video signal and displaying the video on the virtual display 33, and a function of acquiring and transmitting the video signal from the virtual camera 35.

The user U1 of the glasses-free AR display device 10 is displayed on the virtual display 33. Since the virtual camera 35 is not a real object, the video of the virtual display 33 viewed by the avatar A is not shielded at all. Therefore, the virtual camera 35 can be desirably disposed at the height of the eyes of the user U1 displayed on the display 13.

The video controller 16 of the glasses-free AR display device 10 and the video controller 36 of the virtual glasses-free AR display device 30 are connected via the transmission network 21. Thus, the glasses-free AR display device 10 and the virtual glasses-free AR display device 30 can mutually transmit and receive video signals.

The user U1 using the glasses-free AR display device 10 is reflected on the half mirror 11 of the glasses-free AR display device 10. The avatar A located in front of the virtual mirror 31 is reflected on the virtual mirror 31 of the virtual glasses-free AR display device 30.

The video of the user U1 reflected on the half mirror 11 captured by the camera 15 of the glasses-free AR display device 10 is displayed on the virtual display 33 of the virtual glasses-free AR display device 30. The video of the avatar A captured by the virtual camera 35 of the virtual glasses-free AR display device 30 is displayed on the display 13 of the glasses-free AR display device 10.

Thus, the user U1 using the glasses-free AR display device 10 can view the own video (mirror image) reflected on the half mirror 11 of the glasses-free AR display device 10 and the video of the avatar A displayed on the display 13 of the glasses-free AR display device 10. On the other hand, the avatar A can view its own video reflected on the virtual mirror 31 of the virtual glasses-free AR display device 30 and the video of the user U1 displayed on the virtual display 33 of the virtual glasses-free AR display device 30.

For example, since the user U1 views the video of the avatar A displayed on the display 13 next to the video (mirror image) of the user himself/herself reflected on the half mirror 11, the user U1 can feel that the avatar A is adjacent in the same room. The same applies to the avatar A.

For example, the avatar A may be a Virtual Youtuber (Vtuber) and the user U1 may be a fan of the Vtuber. In this case, the user UI can enjoy a feeling that a Vtuber having no actual body is present next to the user U1 in the same room in the real world. In other words, the user U1 can obtain the feeling of participation in Vtuber in the virtual world and a fan meeting in the real world.

The space sharing system illustrated in FIG. 4 further includes a distribution camera 22 and a transmitter 23 like the system illustrated in FIG. 3.

The distribution camera 22 is disposed in front of the half mirror 11 of the glasses-free AR display device 10. For example, the distribution camera 22 is disposed directly in front of the center of the half mirror 11 of the glasses-free AR display device 10. The distribution camera 22 can capture the user U1 reflected on the half mirror 11 and the avatar A displayed on the virtual display 33. That is, the distribution camera 22 can capture the user U1 and the avatar A at a third person viewpoint.

The transmitter 23 transmits the video signal for distribution captured by the distribution camera 22 to the transmission network 21. The video signal for distribution is received by a reception device 24 (for example, a computer) included in a plurality of users U3, and the videos of the user U1 and the avatar A are reproduced. Thus, each user U3 can view the videos of the user U1 and the avatar A in real time.

The space sharing system illustrated in FIG. 4 further includes the distribution server 25 and the distribution storage 26 as in the system illustrated in FIG. 3. Functions or operations of the distribution server 25 and the distribution storage 26 are the same as those of the system illustrated in FIG. 3.

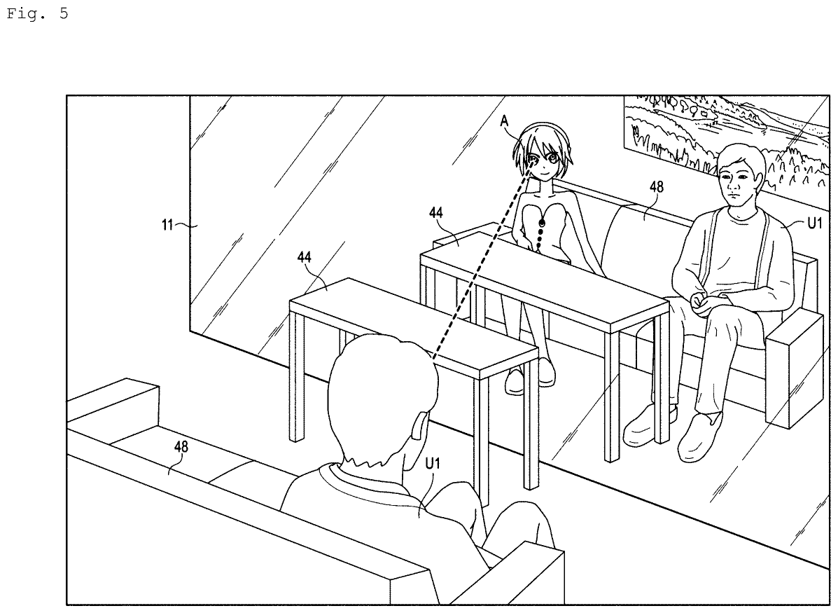

FIG. 5 is a diagram illustrating a state of the use of the glasses-free AR display device 10 illustrated in FIGS. 1 and 2. In FIG. 5, an actual user U1 is drawn in a foreground, and the user U1 reflected on the half mirror 11 and the conversation partner, that is, the avatar A displayed on the display 13 are drawn in a background. A chair-like structure having at least two seats is disposed in front of the half mirror 11. In FIG. 5, the chair-like structure is drawn as a sofa 48. The sofa 48 is disposed in front of the half mirror 11 so that an arrangement direction of a seat is parallel to the surface of the half mirror 11. Further, a long desk 44 is disposed between the half mirror 11 and the sofa 48. The long desk 44 is disposed so that a longitudinal direction is parallel to the surface of the half mirror 11.

The user U1 sits on a seat at a right end of the sofa 48 and faces the display 13 side. A seat at a left end of the sofa 48 is vacant, and is located in plane symmetry with the display 13 with respect to the surface of the half mirror 11.

Therefore, the avatar A displayed on the display 13 looks like sitting on the seat at the left end of the sofa 48. As a result, the user U1 can interact with the avatar A in a state where lines of sight coincide with that of the avatar A as indicated by a broken line in FIG. 5.

Here, a case where the chair-like structure having at least two seats is the sofa 48 has been described. However, the chair-like structure having at least two seats may be a set of two or more individual chairs. In this case, the user sits on one chair, the other chairs are vacant, and one of the vacant chairs is disposed in plane symmetry with the display 13 with respect to the surface of the half mirror 11.

Further, a standing position and a depth distance of the user U1 or the avatar A is reproduced with binocular parallax, and the user U1 can have a high feeling of the same room.

### Problems of Concern Regarding AR Display and Solutions

Hereinafter, problems generally concerned with AR display and solutions and an idea for improving the feeling of the same room will be described in connection with the glasses-free AR display device 10 according to the embodiment. That is, a problem to be described hereinafter is not limited to the glasses-free AR display device 10 according to the embodiment.

### Double Images are Visible

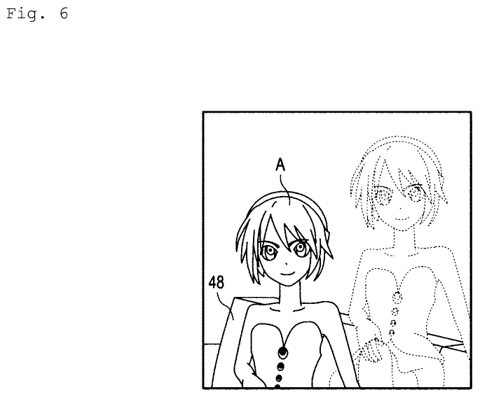

The half mirror 11 has a higher reflectance than that of ordinary glass. To this end, the video displayed on the display 13 is reflected by the half mirror 11, and a reflected video is projected onto display 13 as indicated by a broken line in FIG. 6. As a result, a double image of the video (for example, the avatar A) displayed on the display 13 is seen.

When a screen of the display 13 is non-glare, the double image itself is reduced, but when the screen is mat non-glare, the screen is thin and shines with diffused light, and thus, when the screen is at a short distance of 1 to 2 meters, a non-shining black part of an aerial video is visually observed as a plane, and the aerial video is not formed.

As an improvement measure for reducing the double image, an antireflection film 13a is stuck on a front surface of the display 13, as illustrated in FIG. 2. The antireflection film 13a is not limited thereto, but may be, for example, an antireflection film having a moth-eye structure.

As another improvement measure for reducing the double image, the half mirror 11 has an antireflection film 11a stuck on a rear surface. The antireflection film 11a is not limited thereto, but may be an antireflection film having a moth-eye structure, for example. Further, the antireflection film 11a may be a circularly polarizing film.

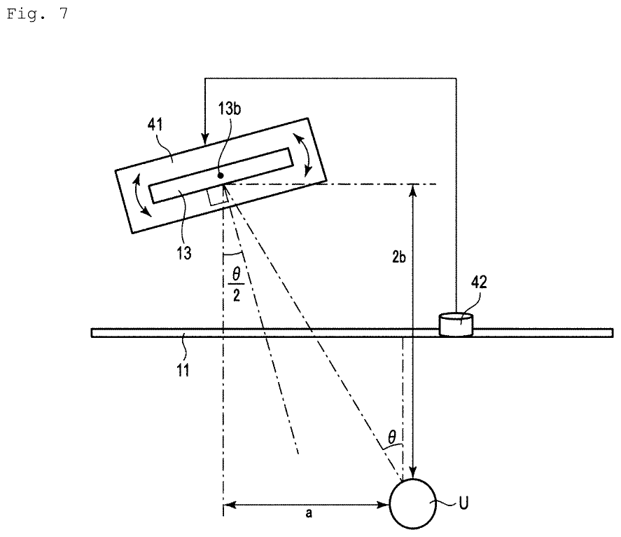

As another improvement measure for reducing the double image, a direction of the display 13 may be changed depending on a position of the user U. To this end, for example, as illustrated in FIG. 7, the glasses-free AR display device 10 includes a rotation mechanism 41 that rotates the display 13, and a person position sensor 42 that senses the position of the user U.

Here, a distance between the user U in a direction parallel to a surface (a front surface or a rear surface) of the half mirror 11 and a conversation partner (for example, avatar A) displayed on the display 13 is a, a distance between the half mirror 11 and the user U in a direction perpendicular to the surface of the half mirror 11 is b, and an angle formed by a normal line standing on the surface (for example, a front surface) of the half mirror 11 and a straight line extending from the conversation partner to the user is Θ. That is, an angle formed by a normal line standing on the surface of the half mirror 11 and a normal line standing on the surface of the display 13 is Θ/2. Further, it is assumed that the conversation partner is displayed at a center of the display 13. A rotary axis 13b of the display 13 passes through the center of the display 13 and extends vertically.

The person position sensor 42 senses the position of the user U and gives position information to the rotation mechanism 41. The rotation mechanism 41 rotates the display 13 by Θ/2 around the rotary axis 13b to maintain tan Θ=a/2b with respect to the distance a, the distance b, and the angle Θ. For example, when a=1.2 m and 2b=2.4 m, the rotation mechanism 41 rotates the display 13 around the rotary axis 13b by Θ/2 to adjust the angle Θ so that tan Θ=0.5 is satisfied.

Under such control of the rotation mechanism 41, the image of the avatar A displayed on the display 13 and the reflected image of the avatar A that is projected onto the display 13 due to reflection appear to overlap with each other from the position of the user U. That is, a double video of the avatar A becomes invisible. In addition, since the avatar A on the display 13 is posed when viewed from an oblique angle of Θ/2 rather than directly in front of U, the avatar A appears more three-dimensionally.

Although the example in which the double video of the avatar A cannot be seen from the position of the user U has been described here, the direction of the display 13 may be controlled by the rotation mechanism 41 so that the double video of the avatar A cannot be seen when viewed from the distribution camera 22. Further, it is may be configured that the direction of the display 13 is fixed, a position where the double video of the avatar A cannot be seen is obtained from this equation in advance, and the user U is guided and disposed to a position where the same condition is satisfied.

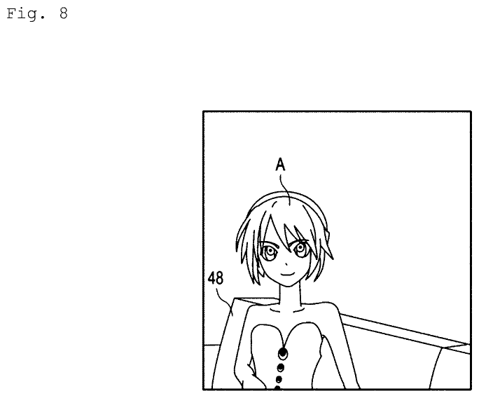

When at least one of the above-described improvement measures is performed, the double video of the avatar A displayed on the display 13 becomes invisible, as illustrated in FIG. 8.

### Video Floating

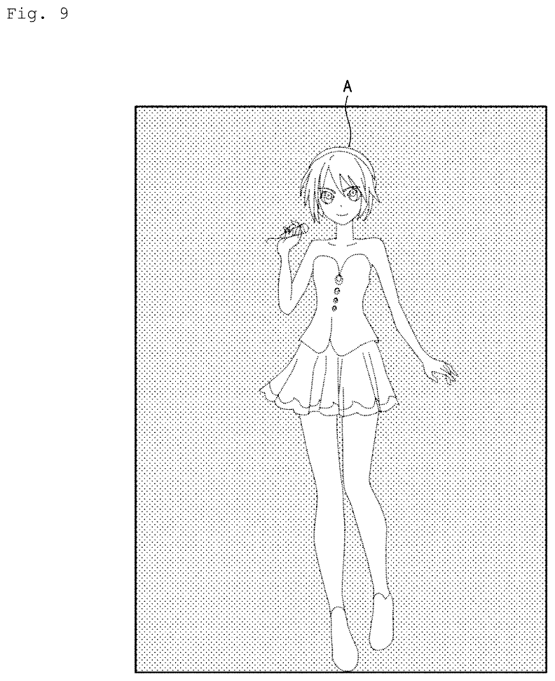

In order to illuminate a user or an object in front of the half mirror 11 by spot illumination, a video of a conversation partner (for example, avatar A) displayed on the display 13 in the darkroom-like structure 12 is floated in a dark space as illustrated in FIG. 9. Therefore, AR is hard to get used naturally.

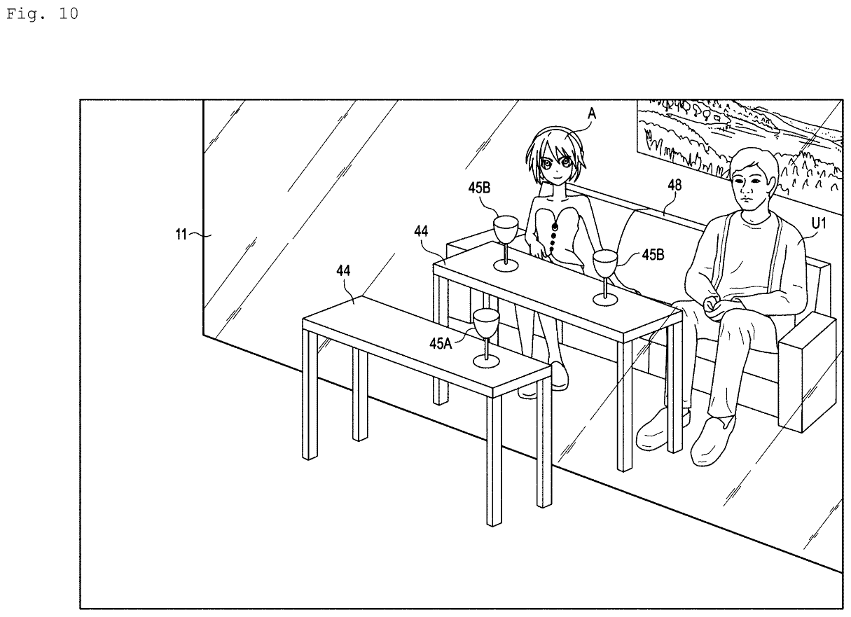

As an improvement measure for this problem, common furniture accompanied by a common animation operation is prepared and displayed as “joint”, and a sense of unity is produced by the common animation operation. FIG. 10 is a diagram illustrating an example thereof. In FIG. 10, the desk 44 and a wine glass 45A are prepared as common furniture, and wine glasses 45B of a video and a mirror image are displayed. Further, as the common animation operation, an operation of sitting on a sofa or drinking wine is shown. This makes AR feel more natural. In FIG. 10, illustration of the user U1 and the sofa originally actually present in the foreground are omitted for convenience in order to describe the situation.

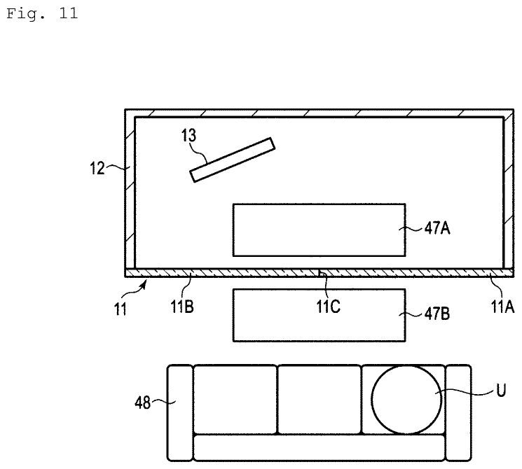

However, further, as another improvement measure, an object is actually placed between the display 13 and the user U. FIG. 11 is a diagram illustrating a state in which a desk 47B is placed between the display 13 and the sofa 48 on which the user U sits and in front of the half mirror 11. Further, a desk 47A is also disposed between the display 13 and the half mirror 11. The desk 47A and the desk 47B are provided in plane symmetry with respect to the half mirror 11. That is, the desk 47A and the desk 47B are structures that are in plane-symmetrical with respect to the half mirror 11. Further, the desk 47A and the desk 47B are disposed at the same distance from the half mirror 11.

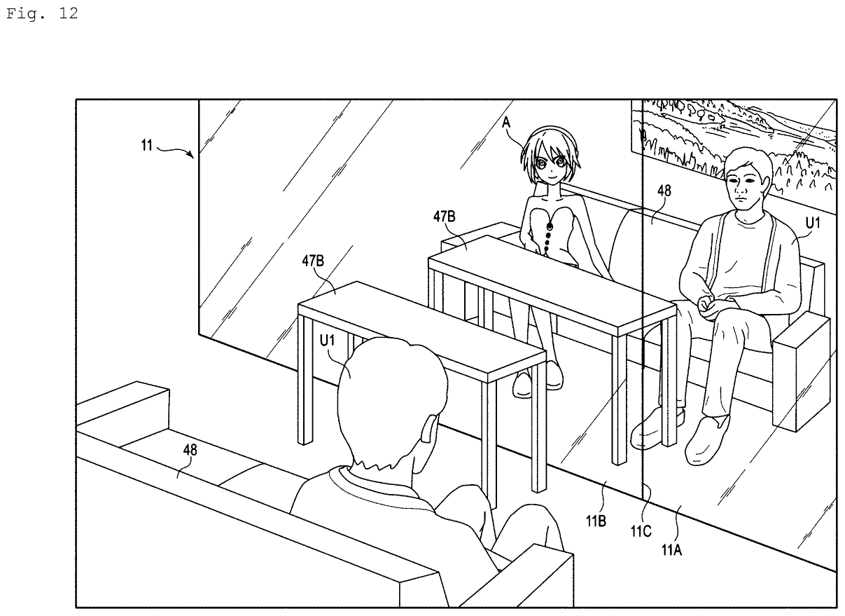

Further, FIG. 12 is a perspective view illustrating a state where the glasses-free AR display device 10 in which the desk 47A and the desk 47B are placed is viewed from the user side, as illustrated in FIG. 11. In FIG. 12, the desk visible at the back is a reflected image of the desk 47B disposed between the half mirror 11 and the sofa 48, and the desk 47A (see FIG. 11) disposed between the half mirror 11 and the display 13 is actually looked only thin from the sofa 48 side.

Thus, when the desk 47B and the desk 47A are disposed between the display 13 and the sofa 48 on which the user U sits, occlusion (a rear object is hidden by a front object) occurs. Thus, there are the desk 47B and the desk 47A (having physical entities in the room) in front of the video of the display 13, and presence of the display 13 at the back is perceived by a motion parallax, and the video of the display 13 is prevented from being floated.

### Uniform Sharpness

The half mirror 11 has a higher reflectance than that of ordinary glass. Therefore, although the user U appears on the half mirror 11 with a high sharpness, a video (for example, avatar A) displayed on the display 13 is displayed with a low sharpness due to the half mirror 11. As a result, a mirror image of the user U seen by the user U and the avatar A may differ in sharpness.

In order to avoid such a problem, in the glasses-free AR display device 10 illustrated in FIGS. 11 and 12, a portion of the half mirror 11 facing the user U has a high reflectance and a low transmittance than a portion facing the display 13. For example, the half mirror 11 includes a first half mirror 11A having high reflectance and low transmittance, and a second half mirror 11B having low reflectance and high transmittance, and the first half mirror 11A and the second half mirror 11B are joined to each other at a boundary 11C.

Thus, the image of the user U1 is clearly reflected on the first half mirror 11A. Since the user U1 views the avatar A displayed on the display 13 through the second half mirror 11B having low reflectance and high transmittance, the user U1 can view a clear video of the avatar A.

### Emote Effects/Moving Feeling in Same Space

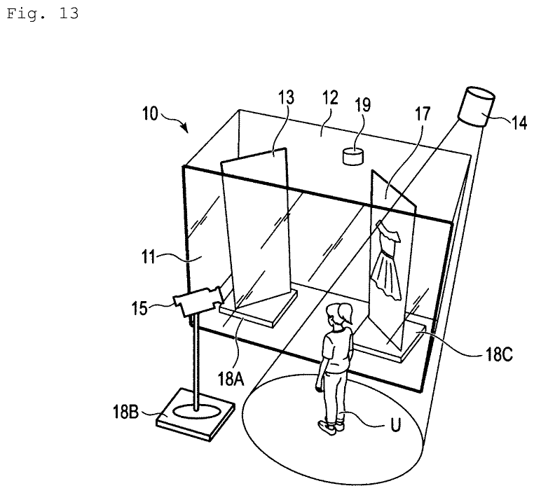

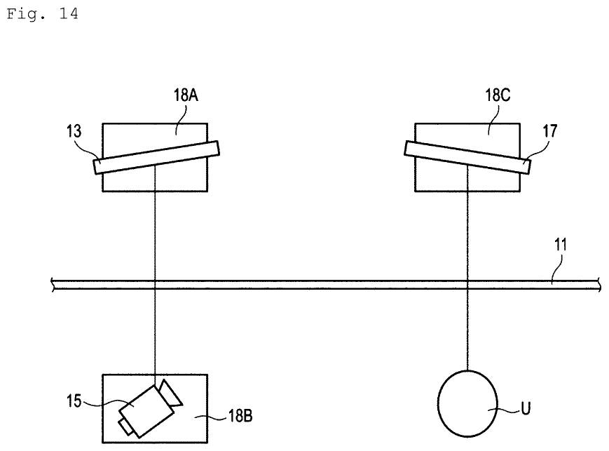

FIG. 13 is a perspective view of the glasses-free AR display device 10 having a sub-display 17 for displaying an emote effect (emote: high emotion expression) or balloon chat characters on a head. Further, FIG. 14 is a plan view of the glasses-free AR display device 10 illustrated in FIG. 13 as viewed from above.

The glasses-free AR display device 10 illustrated in FIG. 13 includes a moving trolley 18A that movably supports the display 13, a moving trolley 18B that movably supports the camera 15, a sub-display 17 for an emote effect, and a moving trolley 18C that movably supports the sub-display 17.

The sub-display 17 is prepared for the purpose of the emote effect, and, for example, displays a figure, a text, and a particle representing the emotion of joy, anger, sorrow, and pleasure of the user U, or display an effect for highlighting the user U. Further, chat characters may be displayed by a balloon. Further, a name, an avatar name, a display name, a belonging group, a shoulder, an on-line status, and the like may be displayed. These display characters may include translated characters or mirror characters. Further, a comment of a distribution viewer or the like may be displayed. Further, as illustrated in FIG. 13, the sub-display 17 may display clothing virtually worn by the user U. In this case, the user U selects a cloth with high lightness, and a part corresponding to the clothe displayed on the sub-display 17 is made dark. Thus, the video captured by the camera 15 becomes a video as if the user U wears the cloth displayed on the sub-display 17. It is possible for the user U to receive the impression of fitting the various clothes by variously changing the clothes displayed on the sub-display 17.

The moving trolley 18A that supports the display 13 moves forward, backward, left, and right on the floor according to the movement of a conversation partner (a person, avatar, or the like) displayed on the display 13. The moving trolley 18B supporting the camera 15 moves forward, backward, left, and right on the floor to maintain the camera 15 at a position plane-symmetrical to the display 13 with respect to the surface of the half mirror 11. The moving trolley 18C supporting the sub-display 17 moves forward, backward, left, and right on the floor to maintain the sub-display 17 at a position plane-symmetrical with the user U with respect to the movement of the user U.

Thus, it is possible to create a video in which a sense of movement of the user U and the conversation partner (person, avatar, or the like) in the same space has been directed.

### Video Becomes Flat

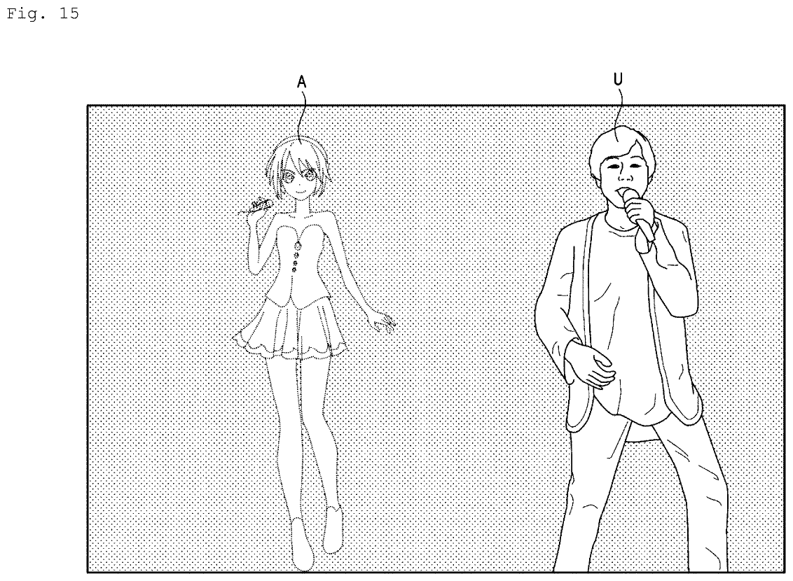

Since the display 13 in the darkroom-like structure 12 is flat in order to illuminate a user or an object in front of the half mirror 11 by spot illumination, an arrangement video of the conversation partner (for example, avatar A) and the user U (for example, co-performer) becomes flat as illustrated in FIG. 15. Therefore, AR is hard to get used naturally.

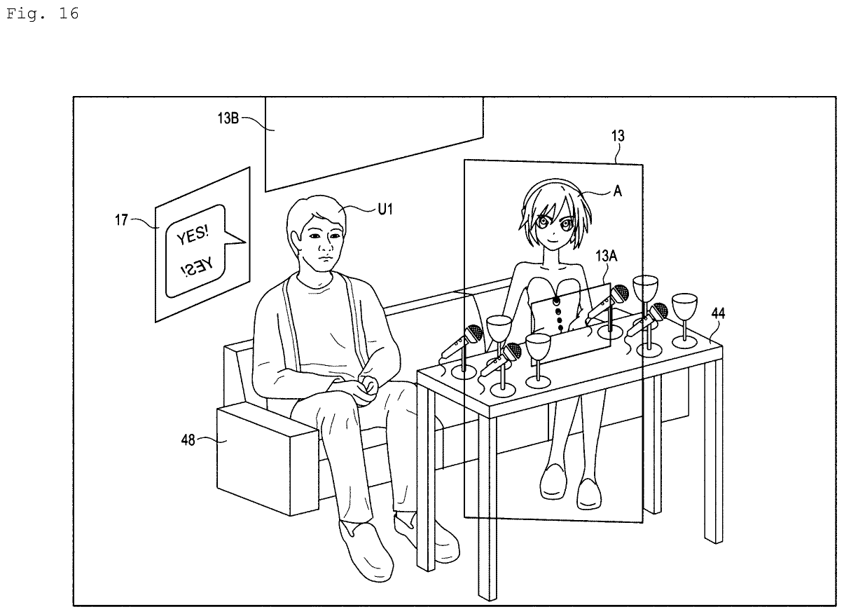

As an improvement measure to this problem, an additional display is provided in addition to the display 13. FIG. 16 is a diagram illustrating the glasses-free AR display device 10 provided with additional displays 13A and 13B, in addition to the display 13. The additional display 13A is provided between the display 13 that displays the avatar A and the half mirror 11. The additional display 13B is provided behind the user U1, for example, on a wall behind the user U1. In FIG. 16, the additional display 13B reflected on the half mirror 11 is drawn.

That is, the additional displays 13A and 13B are disposed at positions where a distance from the half mirror 11 is different from that of the display 13. The additional displays 13A and 13B display videos suitable for the distance from the half mirror 11, respectively. In other words, the video controller 16 (see FIG. 1) displays a video suitable for the distance from the half mirror 11 on the additional displays 13A and 13B.

Thus, the additional displays 13A and 13B are provided at the positions where the distance from the half mirror 11 is different from that of the display 13, and the videos suitable for the distance from the user U1 are displayed on the respective additional displays 13A and 13B, so that the video reflected in the half mirror 11 appears three-dimensional with a display of a plurality of depths, like a pop-up picture book.

For example, a CG image of a new product under design may be displayed on 13A for discussion or Sweets and desserts may be displayed. In 13B, presentation materials may be displayed in a mirrored state and a plurality of people may hold meetings or collaborate, a moving image may be screened and viewed by a plurality of people, or scenery may be displayed to hold meetings, events, or the like as if the people are virtually present there.

Further, the sub-display 17 may display, for example, a character string representing emotion of the user U1. In FIG. 16, a character string “Yes!” is displayed in a first line in the form of a balloon, and a mirror character string of “Yes!” is displayed on a second line. Here, a mirror character string means a character string which can be seen when the character string is reflected on a mirror. In brief, the character string is a character string obtained by horizontally inverting a normal character string. Thus, the character string representing the emotion or the like of the user U1 can be read without difficulty from both the user U1 side and the avatar A side (in other words, the operator side of the avatar A). Thus, it is possible to achieve communication by using a means other than a video. The character string may be, for example, a sentence of chat. In the sentence of the chat, a something input by a keyboard or automatically input through voice recognition may be displayed. Further, the character string may be written in a plurality of languages by using automatic translation or the like. A caption or the like may be displayed. Of course, the sub-display 17 may display somethings other than the character string.

### Occlusion s Incorrect

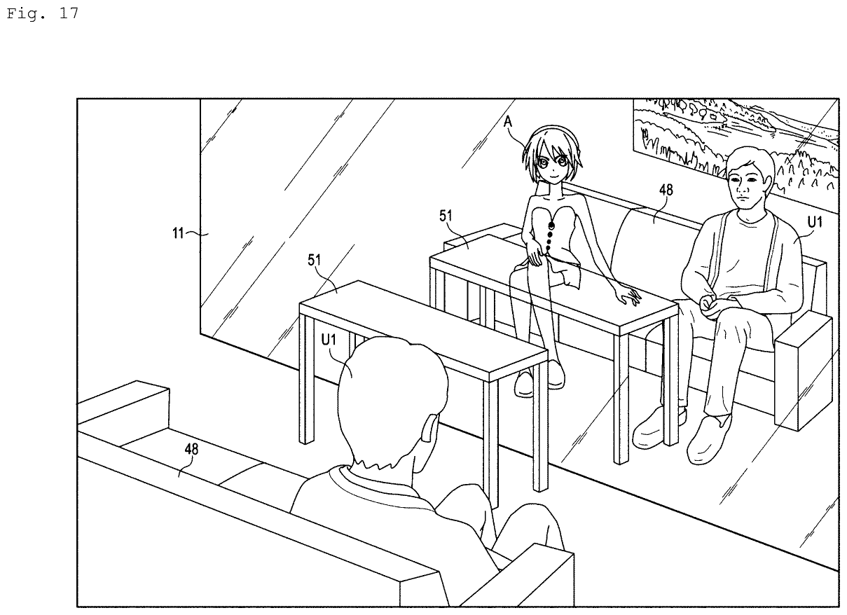

When an object is placed in front of the half mirror 11, the object is reflected on the half mirror 11, but since there is actually no object, the video displayed on the display 13 is seen through, and occlusion (context) is not correct. FIG. 17 is a diagram illustrating a state in which the desk 51 is placed in front of the half mirror 11. As illustrated in FIG. 17, legs of a woman of the avatar A displayed on the display 13 are displayed in front of the desk 51 reflected on the half mirror 11, and occlusion (context) is not correct.

As an improvement measure for this problem, a clone-shaped object may be disposed in plane symmetry with respect to the half mirror 11 in a range in which the distance from the half mirror 11 is 2 m or less (within a maximum distance of 4 m from the user when viewed by a mirror), and a display that displays a room, a landscape, or the like may be disposed behind the user U by 1 m or more in a range in which the distance from the half mirror 11 is 2 m or more (more than 4m away from the user when viewed in a mirror).

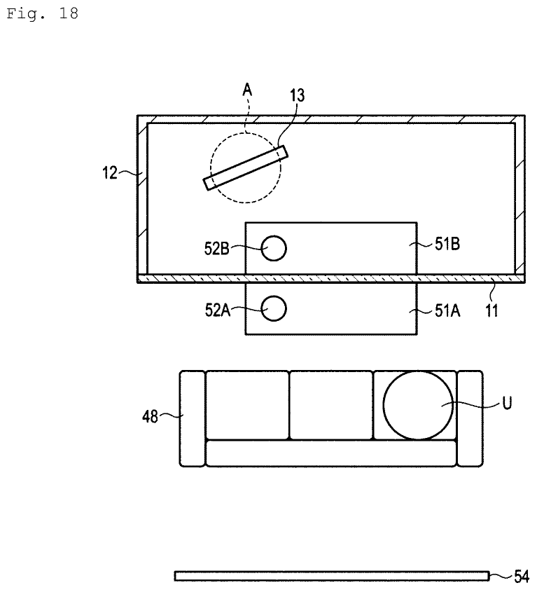

FIG. 18 is a plan view illustrating a state in which a pair of desks 51A and 51B are placed in plane symmetry with respect to the half mirror 11 as described above, and a display 54 is placed behind the sofa 48 on which the user U sits. A pair of wine glasses 52A and 52B are placed on a pair of desks 51A and 51B in plane symmetry with respect to the half mirror 11.

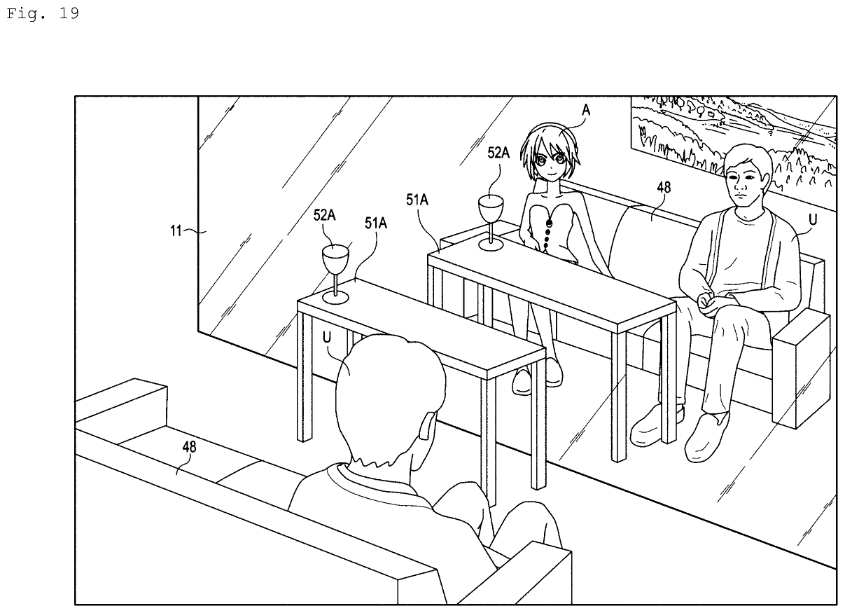

FIG. 19 is a perspective view illustrating a state in which the glasses-free AR display device 10 in which objects (desks 51A and 51B and wine glasses 52A and 52B) and the display 54 are placed as illustrated in FIG. 18 is viewed from the user U side.

As described in connection with FIGS. 11 and 14, in FIG. 19, the desk and wine glass seen at the back are reflection images of the desk 51A and the wine glass 52A disposed between the half mirror 11 and the sofa 48, and the desk 51B and wine glass 52B disposed between the half mirror 11 and the display 13 are actually seen only indistinctly from the sofa 48 side.

In a range in which a distance from the half mirror 11 is 2 m or less (within a maximum distance of 4 m from the user U when viewed by a mirror), a sense of distance of depth due to binocular parallax is sensitive, and thus, when the desk 51A and the wine glass 52A are actually placed between the half mirror 11 and the sofa 48, a strong 3D stereoscopic effect is directed. This is because, in a mirror type video conference of the related art, objects are arranged as a video in one screen of a display, resulting in a flat AR display, whereas in the configuration of this figure, objects actually present in respective depths of real images of the desk 51A and the wine glass 52A in front of the eyes of the user U and images of the desk 51A and the wine glass 52A reflected on the half mirror 11, at distances thereof, are perceived from the user U due to binocular parallax, and thus, a high 3D stereoscopic effect and a high spatial effect are directed.

Further, in view of the motion parallax, the avatar A looks as if the avatar A is hidden by the desk 51A and the wine glass 52A reflected on the half mirror 11 due to the desk 51A and the wine glass 52A placed between the user U and the half mirror 11, and the desk 51B and the wine glass 52B placed between the half mirror 11 and the display 13, and occlusion occurs due to a motion parallax accompanying, for example, a movement of a head part of the user U, and a strong 3D spatial feeling is directed.

The user U sees a video of a room, a landscape, or the like displayed on the display 54 disposed in a rear range of 1 m or more in distance from the user U, which is reflected on the half mirror 11. In the range of 2 m or more of distance from the half mirror 11, the distance is 4 m or more of a target due to a mirror, and the binocular parallax is weakened.

Therefore, a 3D depth feeling is enhanced by a motion parallax generated between a near view and a distant view video of a room or a landscape displayed on the display 54, which is generated with the movement of the head part of the user.

### 3D Discomfort Occurs in Knees

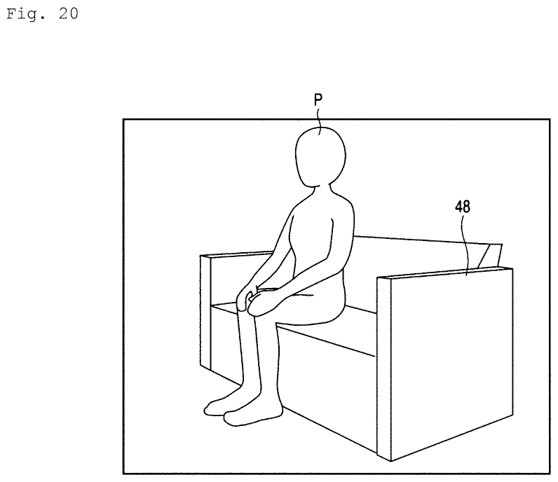

In the glasses-free AR display device 10 according to the embodiment, a distance from the user U to the display 13 that displays a video is approximately 2.68 m and closer than 4 m. Thus, the user U is conscious of the feeling of 3D distance by both eyes. FIG. 20 is a perspective view illustrating a state where a person P sits on the sofa 48. Thus, when the person P sits on the sofa 48, knees are actually ahead of the body approximately 30 to 50 cm. However, when a video in which the conversation partner sits on the sofa 48 is displayed on the display 13, feet are localized at a depth position of a backrest of the sofa 48, and strong 3D discomfort occurs because the display 13 is flat.

As an improvement measure for this problem, a scheme similar to that described with reference to FIG. 11 is adopted. That is, as illustrated in FIG. 11, a desk 47A is placed between the half mirror 11 and the display 13, and the desk 47B is placed in plane symmetry with respect to the half mirror 11.

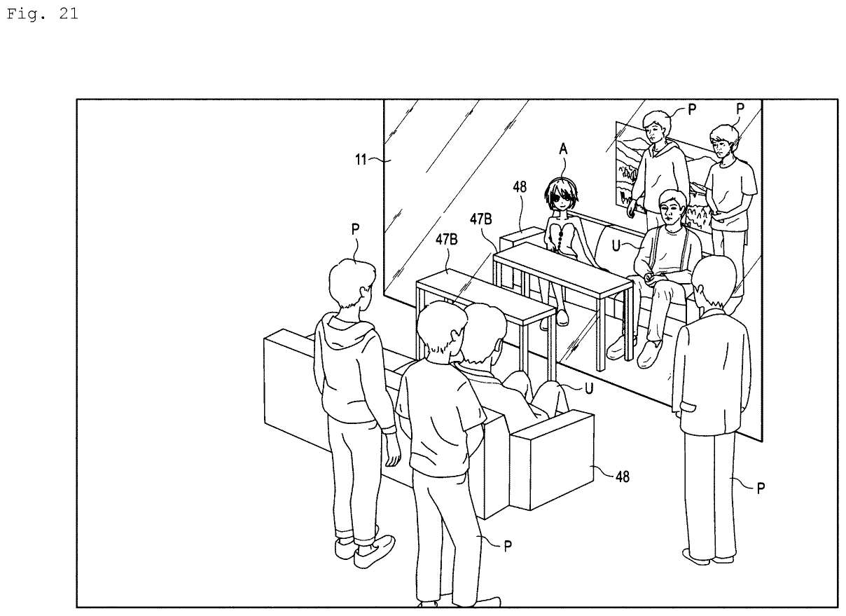

FIG. 21 is a perspective view illustrating a state in which the glasses-free AR display device in which the desks are placed as illustrated in FIG. 11 is viewed from the user side. Knees of the avatar A are not seen from the user U due to the desk 47A placed between the half mirror 11 and the display 13. That is, the desk-like structure 47A disposed at the back of the half mirror 11 blocks a visual field of a knee peripheral part of the conversation partner displayed on the display 13 from the visual field of the user U. Furthermore, the knees of the avatar A are seen in a state where the knees are hidden by the desk 47B reflected on the half mirror 11 from the user U. The user U does not feel 3D discomfort for the knees of the avatar A. In this case, a shin or a toe of the avatar A is not accurate in distance due to the binocular parallax, but occlusion (a rear object is hidden by a front object) occurs between a lower half body of the avatar A and an upper surface and a leg part of the desk by a desk part and a leg part of the desk 47A and the desk 47B, and a strong 3D feeling due to the motion parallax is directed. Further, the knees of the avatar A are seen with a strong 3D feeling without the 3D discomfort from the person P around the desk 47B and the sofa 48, similarly to the user U. Even when the knees are crossed, a part of a root of a foot is hidden from a waist part with the knees exposed in addition to directly hiding the knees, and the continuation of a visual field of the upper half body and the lower half body is blocked, it is possible to direct a strong 3D feeling due to motion parallax without feeling 3D discomfort due to the binocular parallax.

Thus, the conversation partner (for example, avatar A) can be displayed at a closer position, and realistic and powerful glasses-free AR display can be performed. Further, all persons, including the person P present around the user U and a person viewing distribution, in addition to the user U, can naturally view each other.

### See-Through of Video

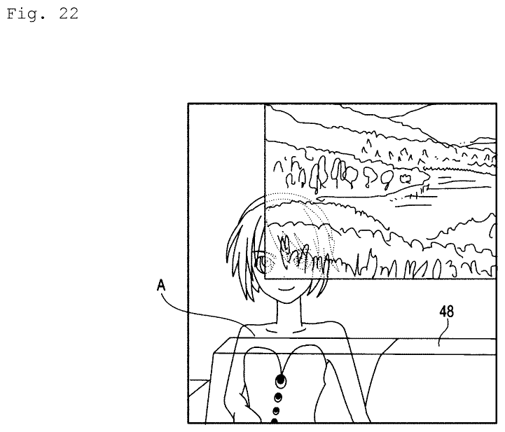

When a background behind the user U is bright, a scene behind the user U is displayed, and the conversation partner (for example, avatar A) displayed on the display 13 is seen through. FIG. 22 schematically illustrates a state in which the video of the avatar A displayed on the display 13 is seen through when the background behind the user U is bright. In FIG. 22, a bright background behind the user U is reflected on the half mirror 11, and a face part of the video of the avatar A is seen through.

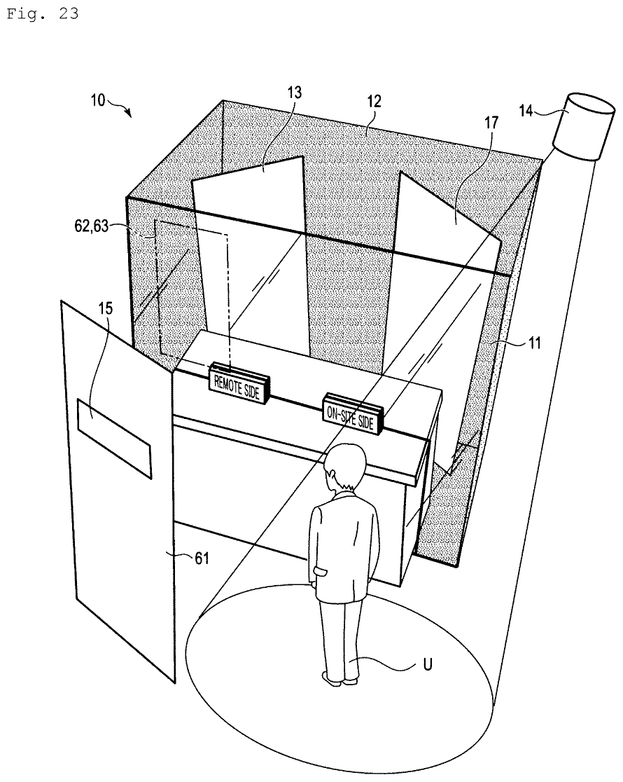

As an improvement measure for this problem, a dark screen may be placed at the position plane-symmetrical to the display 13 with respect to the surface of the half mirror 11. FIG. 23 is a perspective view illustrating a state where the glasses-free AR display device 10 in which a dark screen 61 is placed at the position symmetrical to the display 13 with respect to the surface of the half mirror 11 is viewed from above the user U. The camera 15 is attached to the screen 61 at a position plane-symmetrical to the display 13 with respect to the surface of the half mirror 11. The screen 61 may be a human type. When the screen 61 is disposed, the background behind the user U reflected on the half mirror 11 becomes dark, and the video of the avatar A displayed on the display 13 is prevented from being seen through.

As another improvement measure, an electronic curtain 62 may be provided on the surface (the front surface or the rear surface) of the half mirror 11 as shown by a two-dot chain line, instead of the screen 61 being placed, thereby preventing a video from being seen through. Further, as another improvement measure, a vertically polarizing film 63 may be stuck to the surface (the front surface or the rear surface) of the half mirror 11 as shown by a two-dot chain line, instead of the screen 61 being placed, thereby preventing a video from being seen through. Further, the electronic curtain 62 and the vertically polarizing film 63 may be used in combination with the screen 61.

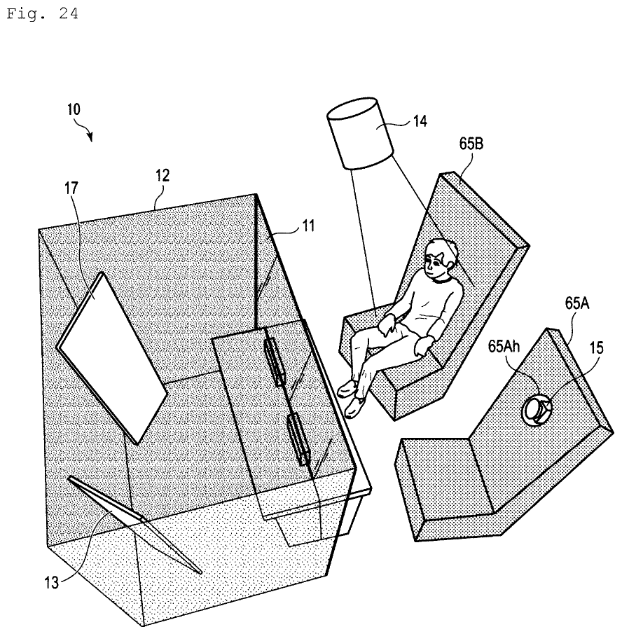

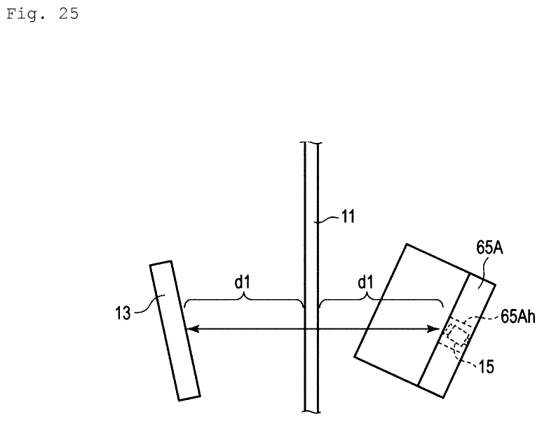

As another improvement measure, a dark high-back chair may be placed at the position substantially plane-symmetrical to the display 13 with respect to the surface of the half mirror 11. In this case, a dark high-back chair is also placed adjacent to such a dark high-back chair, and the user U may sit on the dark high-back chair and conversate. FIG. 24 is a perspective view illustrating a state in which the glasses-free AR display device 10 in which two dark high-back chairs 65A and 65B are placed on the user U side with respect to the half mirror 11 is viewed from above. Further, FIG. 25 is a plan view illustrating a positional relationship between the display, the high-back chair, and the camera with respect to the half mirror in the glasses-free AR display device illustrated in FIG. 24.

The high-back chair 65A is placed so that a backrest part is at the position plane-symmetrical with the display 13 with respect to the surface of the half mirror 11. In the backrest of the high-back chair 65A, a hole 65Ah is formed at a height of the eyes of the user U, and the camera 15 is disposed in the hole 65Ah. Here, the height of the eyes of the user U is assumed to be a height of the eyes when a person with a standard body type sits on the high-back chair 65A.

Specifically, as illustrated in FIG. 25, for example, the high-back chair 65A is disposed such that a line perpendicular to the surface of the half mirror 11 passing through a center of a lens at a tip of the camera 15 disposed in a hole 65Ah of the backrest thereof passes through the center of the display 13, and so that a distance from the center of the lens at the tip of the camera 15 to the half mirror 11 is equal to a distance from the center of the display 13 to the half mirror 11, for example, both of the distances are d1.

The high-back chair 65B is placed adjacent to the high-back chair 65A in a direction parallel to the surface of the half mirror 11. The high-back chair 65B is disposed so that a distance from a backrest part to the half mirror 11 is equal to the high-back chair 65A and equal to the distance from the center of the display 13 to the half mirror 11, on a straight line extending from the center of the display 13 at an angle Θ with respect to a normal line standing on the surface of the half mirror 11. Further, the high-back chair 65B is placed so that a backrest portion faces the display 13 at Θ/2 (see FIG. 7) with respect to a normal line standing on the surface of the half mirror 11. For example, the high-back chair 65A and the high-back chair 65B are disposed at positions on a floor plane-symmetrical to a plane perpendicular to the half mirror 11. The user U uses the glasses-free AR display device 10 in a state in which the user U sits on the high-back chair 65B.

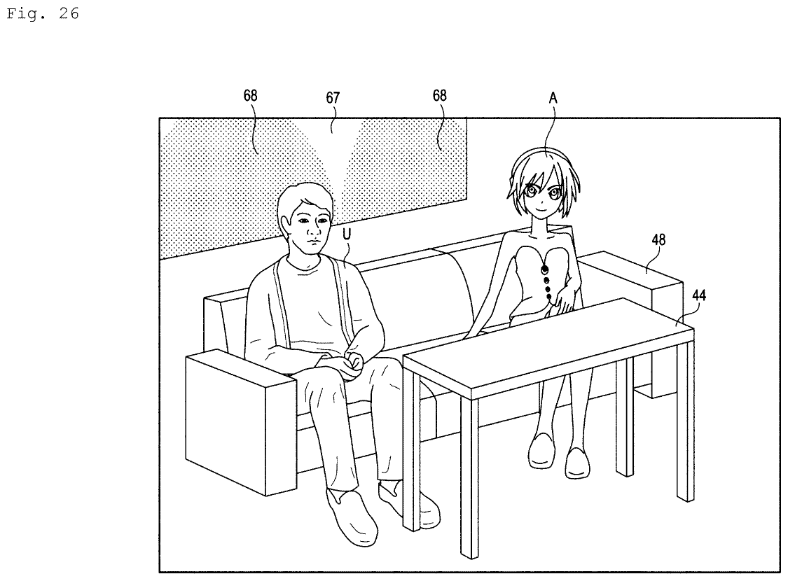

Further, as another improvement measure, a display may be disposed behind the user U, and a video with a wide shadow may be displayed on the display, as described with reference to FIG. 18. FIG. 26 is a diagram illustrating a state in which a shadow 68 is widely added to a back video 67 reflected on the half mirror 11. As illustrated in FIG. 18, the display 54 is disposed behind the user U. The display 54 displays the back video 67 reflected on the half mirror 11. Further, at the back video 67 displayed by the display 54, the shadow 68 is widely formed at a position corresponding to the user U and the conversation partner (for example, avatar A) due to imaging processing on the surface of the half mirror 11. Thus, the brightness of the background behind the user U is reduced, and a video of the conversation partner (for example, avatar A) displayed on the display 13 is prevented from being seen through.

### Video at Third Person Viewpoint is Not Viewed

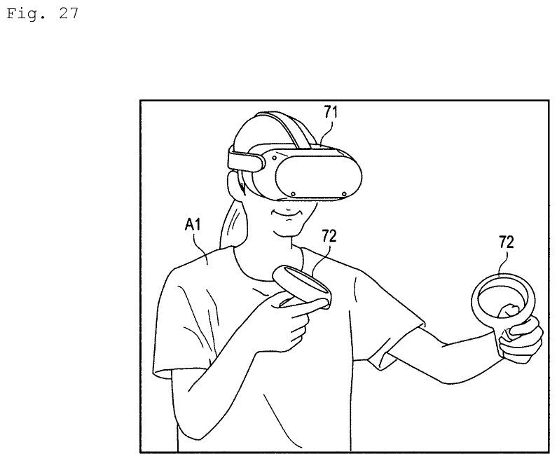

An operator who operates the avatar A may operate the avatar A by wearing a head mount display (HMD). FIG. 27 schematically illustrates an operator A1 operating the avatar A by wearing an HMD 71 and using a hand controller 72. Since the operator A1 wears the HMD 71, a video viewed by the operator A1 becomes a video of the first person's point of view of the avatar A operated by the operator A1. Therefore, the operator A1 looks at a figure of the partner displayed on the virtual display 33 (see FIG. 4), but the operator A1 cannot view a video at a third person viewpoint adjacent to the operator A1 and the partner.

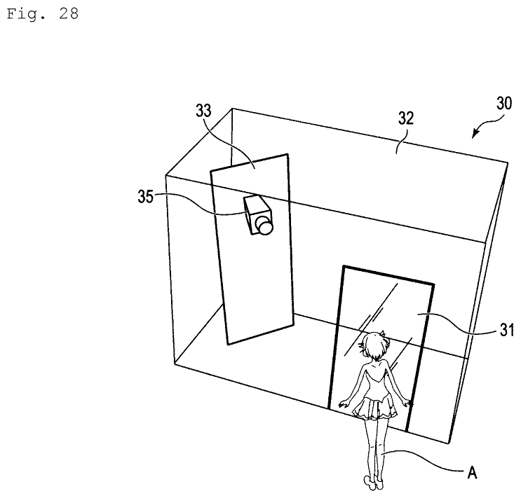

As an improvement measure for this problem, the virtual mirror 31 may be provided on a virtual space (metaverse) side, as illustrated in FIG. 28. FIG. 28 is a perspective view schematically showing a part of the virtual glasses-free AR display device 30 illustrated in FIG. 4. FIG. 4 is as described above. The virtual mirror 31 displays the video of the avatar A as if the avatar A is reflected on the mirror.

Therefore, when the virtual mirror 31 is put in the visual field of the avatar A operated by the operator A1, the operator A1 can view the avatar A reflected on the virtual mirror 31. Thus, the operator A1 wearing the HMD 71 can view the avatar A reflected on the virtual mirror 31 and the partner displayed on the virtual display 33. That is, the operator A1 can view the avatar A and the partner adjacent to each other at a third person viewpoint. In addition, the operator A1 can confirm a facial expression, an emote, a balloon chat, or the like to be expressed by the avatar A instructed by the operator A1, via the avatar A reflected on the virtual mirror 31.

### Video of Overlapped Part is Seen Through/Experience Accompanied by Tactile Sense is Not Possible

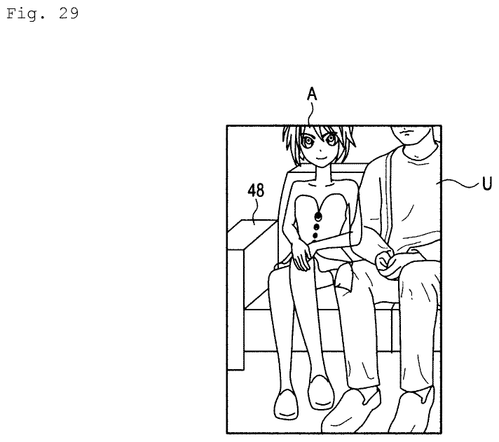

When the video of the user U reflected on the half mirror 11 overlaps the video of the conversation partner displayed on the display 13 on the surface of the half mirror 11, the video of the conversation partner is seen through. FIG. 29 is a diagram illustrating a state in which the video of the conversation partner is seen through when the video of the user U overlaps the video of the conversation partner. In FIG. 29, a video of a portion of the conversation partner (avatar A) overlapped with legs of the user U is seen through.

Further, although the user U sees the conversation partner as if the conversation partner is next to the user U, the user U is unable to experience tactile sensations such as shaking hands, toasting, high-fiving, or hugging. That is, the conversation partner is in a transparent ghost state where the conversation partner is visible to the eyes but there is no physical collision. To this end, although the user U sees the conversation partner as if the conversation partner is next to the user U, the user U cannot actually perform physical communication with the conversation partner.

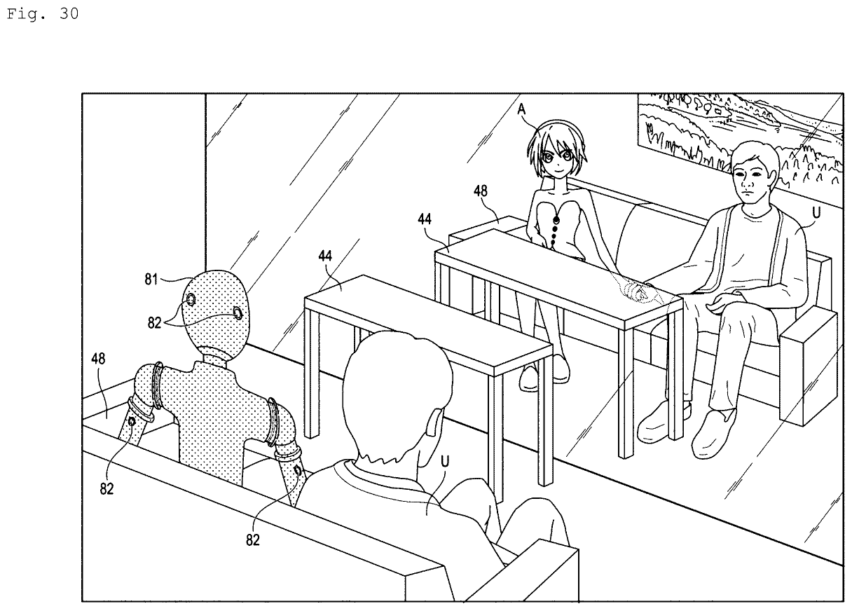

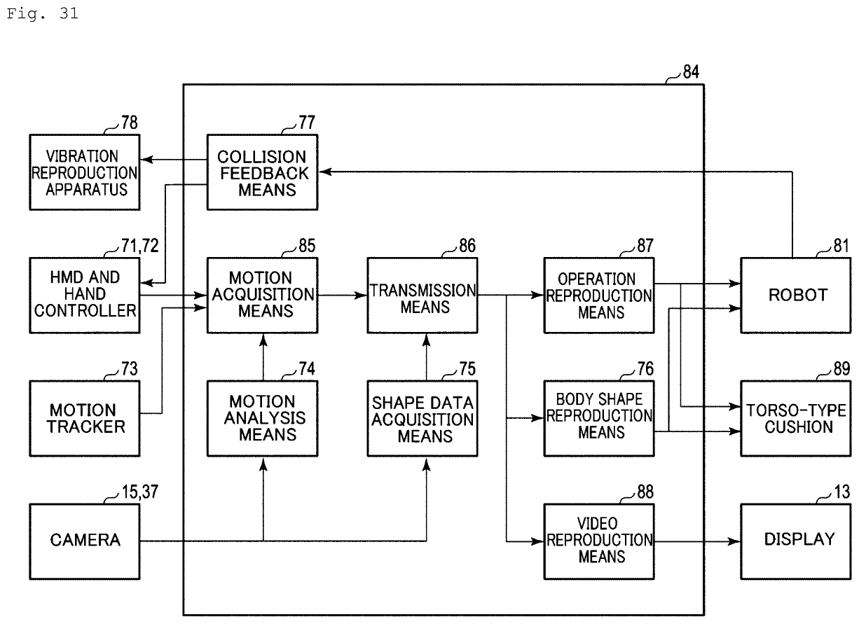

As an improvement measure for this problem, a robot is disposed next to the user U at the position plane-symmetrical to the display 13 with respect to the surface of the half mirror 11, and an operation of the robot is controlled in synchronization with the conversation partner displayed on the display 13. FIG. 30 is a perspective view illustrating a state where a glasses-free AR display device in which a robot 81 is disposed next to the user U is viewed from the user U side. A torso type cushion 89 may be disposed instead of the robot 81. The torso type cushion 89 will be described later. Further, FIG. 31 is a block diagram illustrating a control system 84 that controls operations of the robot 81 and the torso type cushion 89.

In FIG. 30, the avatar A is drawn as a conversation partner of the user U. The robot 81 is disposed next to the user U at the position plane-symmetrical to the display 13 with respect to the surface of the half mirror 11. For example, the robot 81 is disposed adjacent to the user U on the sofa 48 on which the user U sits.

For example, the robot 81 has a skeleton structure similar to a human skeleton structure, and an actuator that drives the skeleton structure. The robot 81 may further include an extensible film-like material covering the skeleton structure, and a shape control mechanism that deforms the shape of the film-like material into any shape. The film-like material imitates human skin and expresses the body shape using a shape thereof. Further, the shape control mechanism constitutes a body shape reproduction means (see FIG. 31) that reproduces a body shape of the conversation partner by controlling a shape of the film-like material. For example, the film-like material is made of rubber having elasticity, and the shape control mechanism can control the shape of the film-like material using air pressure.

The robot 81 is painted black, for example, not to impair the video of the avatar A displayed on the display 13 when the robot 81 is projected onto the half mirror 11. Alternatively, the robot 81 is made of a transparent material.

The robot 81 is operated to imitate the avatar A by the control system 84 illustrated in FIG. 31. More specifically, the robot 81 is controlled in operation to overlap the avatar A on the half mirror 11. That is, the robot 81 is controlled to operate in plane symmetry with the avatar A. To this end, markers 82 for position detection are attached to a plurality of locations on the robot 81 in order to ascertain an accurate position of each part of the robot 81. In order to detect a position of the marker 82 attached to the robot 81 in the three-dimensional space, a three-dimensional grid sensor, for example, is provided in a space where the robot 81 and the user U are present.

As illustrated in FIG. 31, the control system 84 includes a motion analysis means 74, a shape data acquisition means 75, a body shape reproduction means 76, a collision feedback means 77, a motion acquisition means 85, a transmission means 86, an operation reproduction means 87, and a video reproduction means 88.

The control system 84 receives the video of the avatar A displayed on a camera 37 that captures the operator A1 of the avatar A or the display, information from the HMD 71 worn by the operator A1 of the avatar A, the hand controller 72, and a motion tracker 73, and controls the robot 81 (and a torso type cushion to be described later).

Here, the HMD 71 and the hand controller 72 are worn by the operator A1 of the avatar A and detect a motion of the operator A1 of the avatar A. Motion information is received by the motion acquisition means 85 from the HMD 71 and the hand controller 72 and transferred to the transmission means 86 as it is. Here, eye tracking information, vital data, voice recognition, emote based on facial expression recognition, and the like may be transmitted in association with motion information.

Here, the motion tracker 73 may be any type as long as the motion tracker can detect the motion of the operator A1 of the avatar A. For example, this may be a cloth including a plurality of detectable targets worn by an operator A1, and a system that detects the plurality of targets.

Further, the control system 84 transfers physical collision or contact feeling as vibration to the conversation partner via a vibration reproduction device 78 provided on the conversation partner side from the operation of the robot 81.

When the conversation partner is a person, the motion analysis means 74 receives the video signal from the camera 15 that captures the conversation partner, and analyzes the motion of the conversation partner. Further, the video signal of the conversation partner displayed on the display may be used as an input of the video signal directly or through re-capturing a camera video. The motion acquisition means 85 receives the information from the motion analysis means 74 and acquires the motion of the conversation partner. The shape data acquisition means 75 receives the video signal from the camera 15, transfers the video signal to the transmission means 86 as it is, and acquires shape data related to the body shape of the conversation partner.

When the conversation partner is an avatar, the motion analysis means 74 receives a captured moving image obtained by capturing the video of the avatar A displayed on the camera 37 that captures an operator of the avatar or the display, and analyzes the motion of the avatar. The shape data acquisition means 75 receives the captured moving image from the camera 37, transfers the moving image to a transmission means 86 as it is, and acquires the shape data related to the body shape of the operator of the avatar. The motion acquisition means 85 receives the information from the motion analysis means 74 and acquires the motion of the operator of the avatar. The shape data acquisition means 75 receives the captured moving image from the camera 37 and acquires the shape data related to the body shape of the operator of the avatar. Of course, the shape data of the avatar may be directly obtained from an external program.

For example, the motion analysis means 74 and the shape data acquisition means 75 may be provided inside the video controller 16 illustrated in FIGS. 1, 3 and 4, and the transmission means 86 may be configured of the transmission network 21 illustrated in FIGS. 3 and 4. That is, the image analysis by the motion analysis means 74 and the shape data acquisition means 75 may be performed on the side where the camera 15 or the camera 37 are installed.

The motion acquisition means 85 transfers the acquired motion of the conversation partner to the transmission means 86. Further, the shape data acquisition means 75 transfers the acquired shape data related to the body shape of the conversation partner to the transmission means 86.

The transmission means 86 transmits the video signals acquired by the cameras 15 and 37, information on the motion of the conversation partner acquired by the motion acquisition means 85, and shape data regarding the body shape of the conversation partner acquired by the shape data acquisition means 75 to the glasses-free AR display device 10 on the user U side. The transmission means 86 may be included in the video controller 16 of the glasses-free AR display device 10 on the conversation partner side or the video controller 36 of the virtual glasses-free AR display device 30.

The video reproduction means 87 receives the video signal transmitted from the transmission means 86, and displays the video of the conversation partner on the display 13. The video reproduction means 87 may be included in the video controller 16 of the glasses-free AR display device 10 on the user side. Further, the body shape reproduction means 88 receives the shape data transmitted from the transmission means 86, and controls the shape of the film-like material covering the skeleton structure of the robot 81 on the basis of the shape data. Thus, the appearance shape of the robot 81 becomes close to the body shape of the operator of the avatar A. Therefore, the user U can feel the sensation of directly touching the operator of the avatar A.

The operation reproduction means 88 receives the information on the motion of the conversation partner transmitted from the transmission means 86 and controls the operation of the robot 81. In this case, the operation reproduction means 88 also acquires information on the position of each part of the robot 81 by using the marker 82 for position detection attached to the robot 81, and controls the operation of the robot 81 so that the video of the robot 81 reflected on the half mirror 11 completely overlaps the video of the conversation partner on the half mirror 11. That is, in the operation reproduction means 88, each part of the robot 81 is located at the position plane-symmetrical to each part of the conversation partner (for example, the avatar A in FIG. 30) with respect to the surface of the half mirror 11, and controls the robot 81 to perform an operation bilaterally symmetrical to the avatar A.

With such a configuration, for example, when the user U turns the arm to the back of the robot 81, the arm of the user U is blocked by the black-colored robot 81 and is not reflected on the half mirror 11. Thus, the video of the conversation partner on the half mirror 11 is prevented from being seen through.

Further, the robot 81 performs a plane-symmetrical operation with respect to the conversation partner (for example, the avatar A in FIG. 30) with respect to the surface of the half mirror 11. Therefore, when the user U touches the conversation partner in the video of the half mirror 11, a physical contact feeling is obtained from the robot 81. Thus, the user U is able to feel experience with the conversation partner accompanied by tactile sensations such as shaking hands, toasting, high-fiving, or hugging. In FIG. 30, a state in which the user U holds the hands with the avatar A is drawn, as an example. The user U can perform physical communication with the conversation partner though it is pseudo. Further, the collision feedback means 77 acquires contact information from the robot 81 and transmits the contact information to the vibration reproduction device 78 on the conversation partner side, and the vibration reproduction device 78 expresses the contact feeling as vibration.

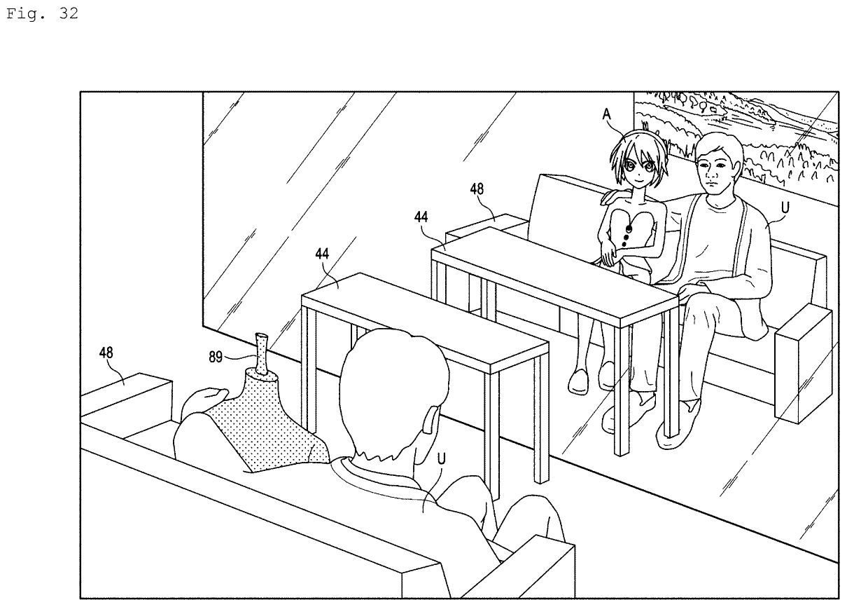

As another simple improvement measure, for example, as illustrated in FIG. 32, a cushion, for example, the torso type cushion 89 may be disposed next to the user U at the position plane-symmetrical to the display 13 with respect to the surface of the half mirror 11. FIG. 32 is a perspective view illustrating a state of a glasses-free AR display device in which the torso type cushion 89 is disposed next to the user U, viewed from the user U side.

The torso-type cushion 89 is an object that has imitated a body portion other than a head part, both arm tips, and both legs of a person. The torso type cushion 89 is disposed on a seat surface adjacent to the user U sitting on the sofa 48 at the position plane-symmetrical to the display 13 with respect to the surface of the half mirror 11. Further, the torso-type cushion 89 may include a stretchable film-like material, and a shape control mechanism that deforms a shape of the film-like material into any shape, similarly to the robot 81. The torso type cushion 89 is painted black, for example, not to impair the video of the avatar A displayed on the display 13 when the torso type cushion 89 is projected onto the half mirror 11. Further, the torso type cushion 89 is divided into, for example, three blocks which are a head part, a body part, and a waist part, and the head part and the waist part may be joined to the body part by joints and moved forward, backward, left, right, up, and down by an actuator. Further, the head part may include a mouth or nostrils, a tongue, an uttering mechanism, heat generation, a perspiration mechanism, a fragrance generation mechanism, a wig, or the like.

With such a configuration, for example, when the user U turns the arm to the back of the torso type cushion 89, the arm of the user U is blocked by the black-colored torso type cushion 89, and is not reflected on the half mirror 11. Thus, the video of the avatar A on the half mirror 11 is prevented from being seen through. Further, the user U can obtain a physical contact feeling from the torso type cushion 89. Thus, the user U can feel the avatar A and the experience accompanied by the tactile sense. That is, the user U can perform physical communication with the conversation partner though it is pseudo.

### Effects

As described above, in the glasses-free AR display device 10 according to the embodiment and the space sharing system using the glasses-free AR display device 10, the user can conversate in a state where a line of sight of the user coincides with the conversation partner by the naked eyes. Further, the user hardly feels a flatness feeling of the conversation partner even at a close distance, easily obtains a correct depth feeling, and easily obtains a feeling of the same room where the conversation partner is adjacent.

Since the user views his or her own video (mirror image) reflected on the half mirror 11, no delay occurs in the video of the user. The glasses-free AR display device 10 has a simple structure and can be configured at a low cost. Not only the user but also persons around the user U or the person viewing the distribution can naturally view each other at a correct depth and standing positions.

### Use Example of Glasses-Free AR Display Device 10

Hereinafter, some examples of space sharing which can be considered to be realized using the glasses-free AR display device 10 will be described with reference to the drawings.

### Space Sharing Example 1

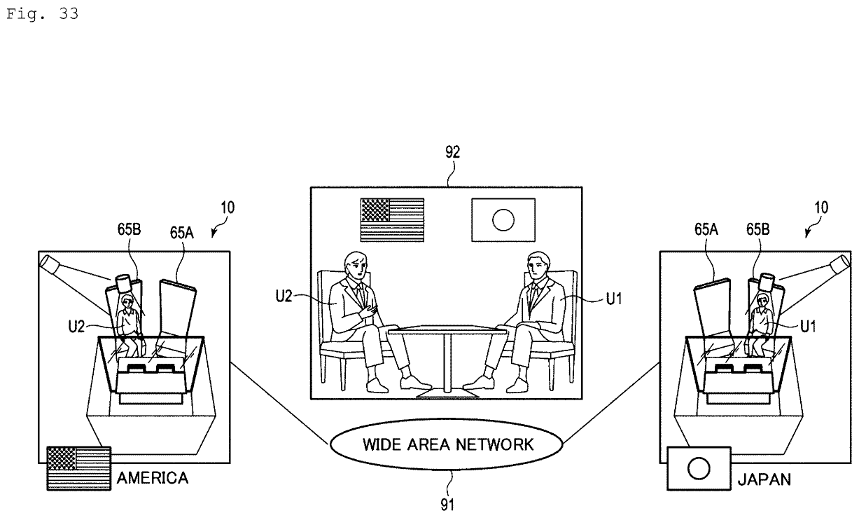

FIG. 33 is a diagram illustrating an example in which a fusion space between an on-site (local side) and a remote side is created using the glasses-free AR display device 10 according to the embodiment. The two glasses-free AR display devices 10 can communicate via a wide area network 91. In each glasses-free AR display device 10, improvement measures for preventing the videos of the users U1 and U2 from being seen through are performed by using the high-back chairs 65A and 65B. A table, chairs, and national flags are displayed on a distribution video 92 as a furniture of the joint, and an improvement measure for preventing floating of the videos of the users U1 and U2 is performed.

### Space Sharing Example 2

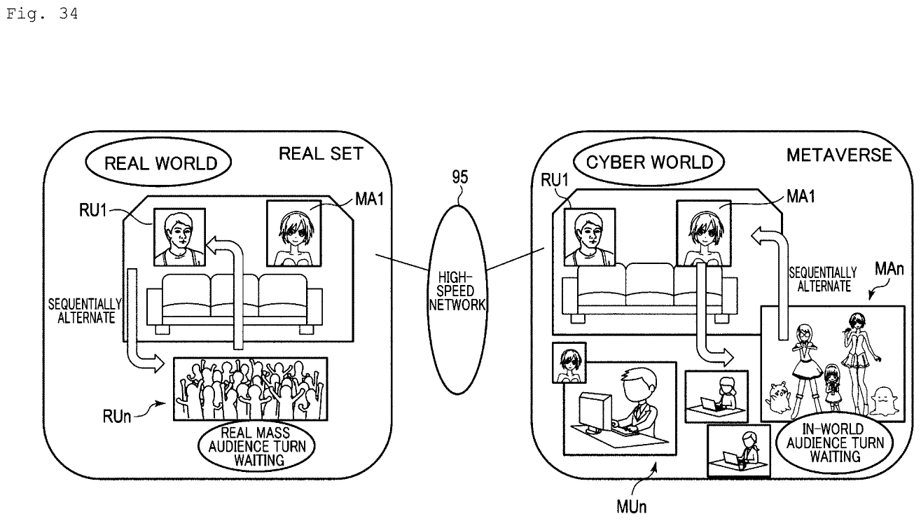

FIG. 34 is a diagram illustrating an example of creating a fusion space between a real world and a cyber world by using the glasses-free AR display device 10 according to the embodiment as another space sharing example. In the real world, the glasses-free AR display device 10 is installed. Further, the virtual glasses-free AR display device 30 is installed in the cyber world. In other words, in the real world, a real set (actual room) that is an entrance from the real world is created in a venue. Further, in the cyber world, a world including a clone space of a room on a metaverse is created. The real set (glasses-free AR display device 10) of the real world and a world (virtual glasses-free AR display device 30) on the metaverse can communicate with each other via a high-speed network 95.

In the real world, a plurality of real mass audience RUn (n=1, 2, . . . ) wait for participation in the real set (glasses-free AR display device 10). In the cyber world, the plurality of in-world audience MUn (n=1, 2, . . . ) and a plurality of avatars MAN (n=1, 2, . . . ) wait for participation in the world (virtual glasses-free AR display device 30) on a metaverse.

The plurality of real mass audience RUn sequentially and alternately participates in the real set (glasses-free AR display device 10). Further, the plurality of in-world audience MUn sequentially and alternately participate in the world (virtual glasses-free AR display device 30) on the metaverse by using the avatar MAn of one person.

In FIG. 34, as an example, a state in which a real participant RU1, which is one of the real mass audience RUn, participates in the real set (glasses-free AR display device 10), and an avatar MAI of an in-world audience MU1, which is one of the in-world audience MUn, participates in the world (virtual glasses-free AR display device 30) on the metaverse is drawn. The real participant RUI is displayed on the virtual display 33 of the virtual glasses-free AR display device 30, and the avatar MA1 is displayed on the display 13 of the glasses-free AR display device 10 in synchronization substantially in real time by the high-speed network 95.

Thus, the real participant RU1 and the in-world audience MU1 can share time while having the feeling of the same room through the avatar MAI.

### Space Sharing Example 3

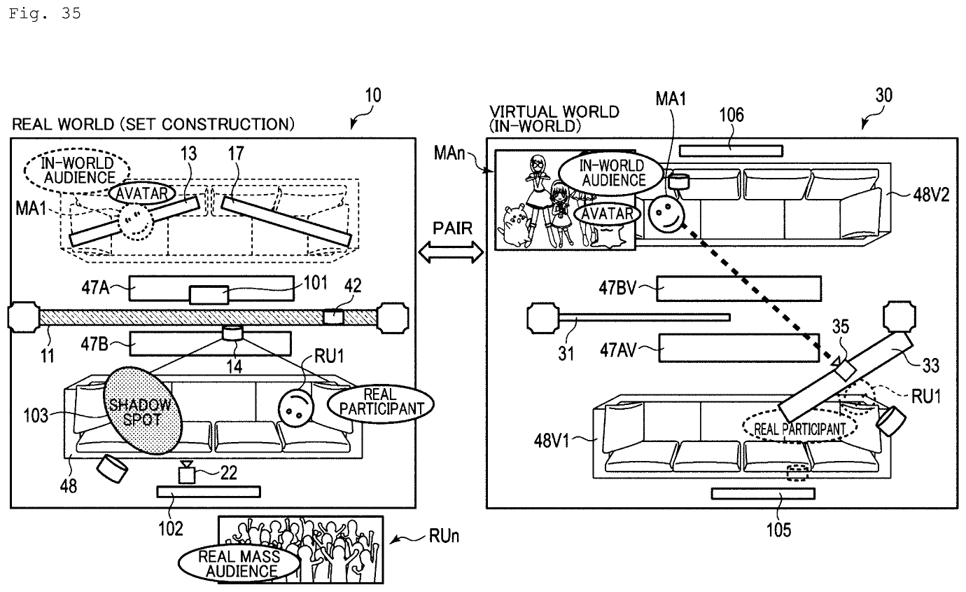

FIG. 35 is a diagram illustrating an example of a system in which a real world (set construction) and a virtual world (in-world) are joined as a pair by using the glasses-free AR display device 10 according to the embodiment as another space sharing example.

The glasses-free AR display device 10 is installed in the real world (set construction), and the virtual glasses-free AR display device 30 is installed in the virtual world (in-world). The glasses-free AR display device 10 and the virtual glasses-free AR display device 30 can communicate with each other via a high-speed network (not shown).

In the real world (set construction), the person position sensor 42 (see FIG. 7), the desks 47A and 47B and the sofa 48 (see FIG. 11 together), and displays 101 and 102 are provided in addition to the half mirror 11, the display 13, the illumination 14, and the camera 15 as components of the glasses-free AR display device 10.

The display 101 is disposed on the desk 47A, is used for an object AR, and displays an object for the AR. The display 102 is disposed behind the sofa 48, is for information sharing, and displays a video for projecting the shared information onto the half mirror 11. One of a plurality of real mass audience RUn (n=1, 2, . . . ) participates in the real world (set construction) as a real participant, as in space sharing example 2 described above. An improvement measure for shielding a part of the illumination light from the illumination 14 using a light shielding member (not shown), forming a shadow spot 103 at the position plane-symmetrical to the display 13 with respect to the surface of the half mirror 11, and preventing the video of the avatar A displayed on the display 13 from being seen through is performed. In FIG. 35, a virtual image of the sofa 48 is drawn by a broken line.

On the other hand, in the virtual world (in-world), virtual desks 47AV and 47BV, virtual sofas 48V1 and 48V2, and virtual displays 105 and 106 are also provided as components of the virtual glasses-free AR display device 30, in addition to the virtual mirror 31 and the virtual display 33.

The virtual desks 47AV and 47BV and the virtual sofas 48V1 and 48V2 are virtual objects corresponding to the desks 47A and 47B and the sofa 48, respectively. The virtual displays 105 and 106 are disposed behind the virtual sofas 48V1 and 48V2, respectively. The virtual displays 105 and 106 are used for information sharing and display a video of the shared information like the display 102. One of the plurality of in-world audience MUn (n=1, 2, . . . ) participates in the virtual world (in-world) by using its own avatar MAn, as in the space sharing example 2 described above.

Thus, it is possible for one of the plurality of real mass audience RUn (n=1, 2, . . . ) and one of the plurality of in-world audience MUn (n=1, 2, . . . ) to virtually experience conversation in the same room in each of the real world (set construction) and the virtual world (in-world) by constructing a pair of real world (set construction) and virtual world (in-world).

### Space Sharing Example 4

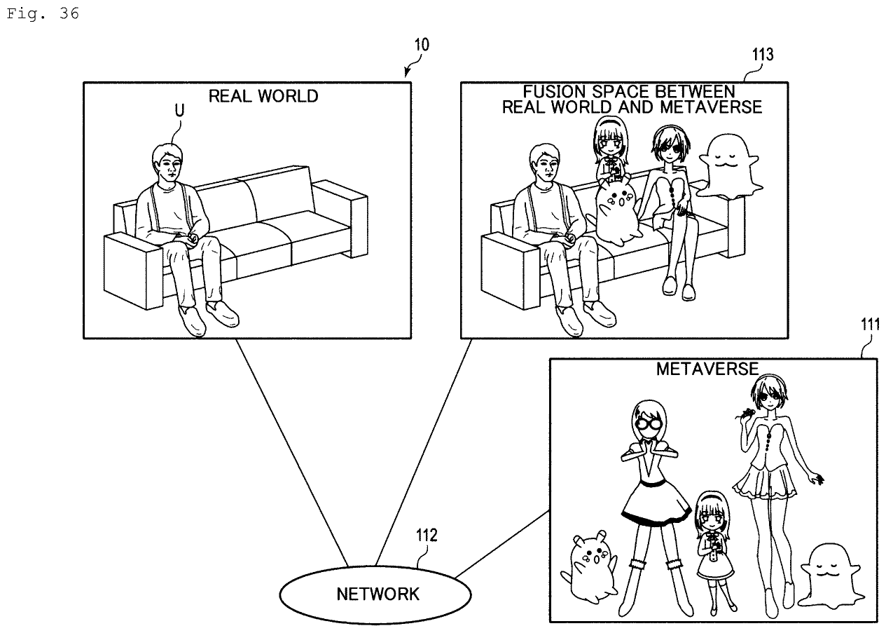

FIG. 36 is a diagram illustrating an example of creating a fusion space of the real world and the metaverse by using the glasses-free AR display device 10 according to the embodiment as another space sharing example. In the real world, the glasses-free AR display device 10 is prepared. Further, the metaverse 111 is prepared. The glasses-free AR display device 10 and a generation device (not shown) for the metaverse 111 can communicate with each other via the network 112. It is possible to create a fusion space 113 of the real world and the metaverse by performing transmission from the generation device (not shown) of the metaverse 111 to the glasses-free AR display device 10 via the network 112, and capturing the video projected onto the half mirror 11 using the distribution camera 22 (see FIG. 4) of the glasses-free AR display device

### Space Sharing Example 5

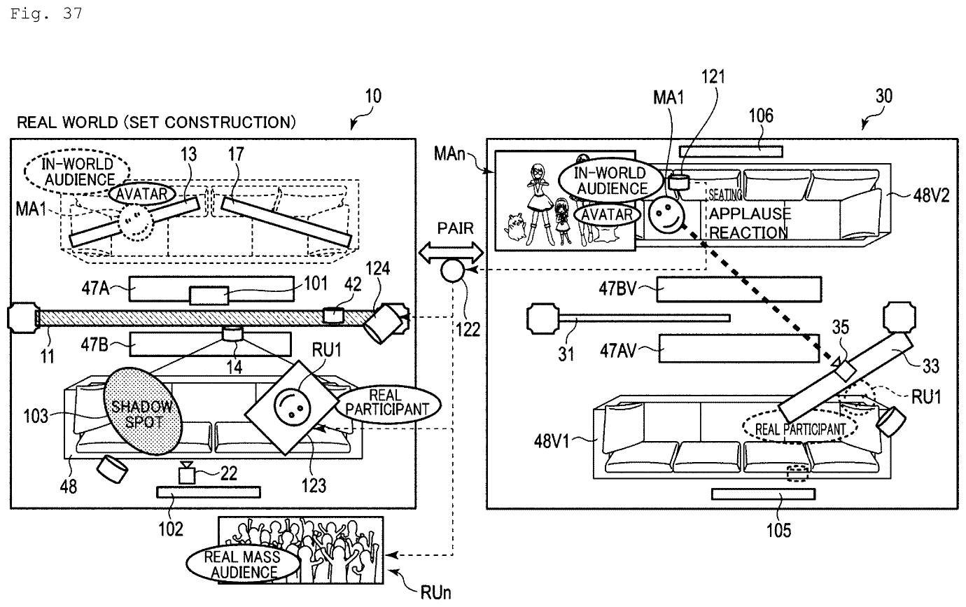

FIG. 37 is a diagram illustrating an example of a system in which a real world (set construction) and a virtual world (in-world) are joined as a pair by using the glasses-free AR display device 10 according to the embodiment as another space sharing example. A configuration of the basic system 1 illustrated in FIG. 37 is the same as a basic configuration of the system illustrated in FIG. 35. That is, in FIG. 37, members denoted by the same reference numerals as those in FIG. 35 denote members similar to those in FIG. 35. In this case, description of these members will be omitted in order to avoid duplication of the description. Hereinafter, differences specific to the system illustrated in FIG. 37 will be described.

In the system illustrated in FIG. 37, the virtual sensor 121 that acquires information on the avatar MA1 is provided in the virtual world (in-world). The information on the avatar MAI is not limited thereto and includes, for example, an action (for example, seating, applause, or a reaction) of the avatar MA1, and an environment (for example, wind, light particles, or aroma) around the avatar MA1. On the other hand, in the real world (set construction), for example, an action reproduction device 123 that reproduces an action of the avatar MA1, and an environment reproduction device 124 that reproduces an environment around the avatar MA1 are provided. The virtual sensor 121, the action reproduction device 123, and the environment reproduction device 124 can communicate with each other via a high-speed network 122, and information of the virtual sensor 121 is instantaneously transferred to the action reproduction device 123 and the environment reproduction device 124.

The action reproduction device 123 includes, for example, a vibration device, and transfers the action (for example, seating, applause, or a reaction) of the avatar MAI to the real participant RUI as a body sonic. The environment reproduction device 124 includes, for example, an air conditioner or a light source device, and provides an environment (for example, wind or optical particles) around the avatar MAI to the real participant RU1. Thus, the real participant RUI can feel the action of the avatar MAI or an environment around the avatar MA1 through five senses. Further, the transfer of the action of the avatar MA1 or the provision of the environment around the avatar MA1 may be performed to all the real mass audience RUn, including the real participant RU1.

Further, a video viewed by the in-world audience MUn through the avatar MAn is not natural at the time of entering or leaving the real participant RUI, that is, during a period from entrance to seating, and during a period from seating to leaving. In order to avoid this, at the time of entering or leaving the real participant RU1, directing may be performed so that the illumination is turned off, or a video of the real participant RU1 gradually appears or gradually disappears, like a science fiction movie, through point cloud data processing or hologram processing.

### Application Example of Glasses-Free AR Display Device 10

Here, an example in which the glasses-free AR display device 10 according to the embodiment is applied to the mirror type video conference has been described. However, an application target of the glasses-free AR display device 10 according to the embodiment is not limited to the mirror type video conference. For example, the glasses-free AR display device 10 according to the embodiment may be applied to any AR technology. For example, the present invention may be applied to AR broadcasting or AR distribution in which a user and a remote conversation partner (a person or avatar) capture a video projected onto the half mirror through AR synthesis using a distribution camera, and broadcast or distribute the video. For example, the present invention may be applied to an AR play in which a video as if the user and the remote conversation partner (a person or avatar) are playing in a play is created through AR synthesis.

The present invention is not limited to the embodiment and can be modified in various forms without departing from the gist of the present invention at an implementation stage. Further, the embodiments may be combined appropriately, and in this case, combined effects can be achieved. Further, the embodiments include various inventions, and various inventions can be extracted by combinations selected from a plurality of disclosed constituent requirements. For example, even when some of constituent requirements disclosed in the embodiments are deleted, a configuration from which the constituent requirements have been deleted can be extracted as the invention as long as the problems can be solved and the effects can be obtained.

### Reference Signs List

10 Glasses-Free AR display device
11 Half Mirror
11a Antireflection film
12 Darkroom-like structure
13 Display
13A, 13B Additional display
13a Antireflection film
13b Rotary axis
14 Illumination
15 Camera
16 Video controller
17 Sub-display
18A, 18B, 18C Moving trolley
21 Transmission network
22 Distribution camera
23 Transmitter
24 Receiver
25 Distribution server
26 Distribution storage
30 Virtual glasses-free AR display device
31 Virtual mirror
32 Darkroom-like virtual structure
33 Virtual display
34 Virtual illumination
35 Virtual camera
36 Video controller
37 Camera
41 Rotation mechanism
42 Person position sensor
44 Desk
45A, 45B Wine glass
47A, 47B Desk
47AV, 47BV Virtual desk
48 Sofa
48V1, 48V2 Virtual sofa
51 Desk
51A, 51B Desk
52A, 52B Wine glass
54 Display
61 Dark screen
62 Electronic curtain
63 Vertically polarizing film
65A, 65B Dark high-back chair
65Ah Hole
67 Background video
68 Shadow
71 HMD
72 Hand Controller
73 Motion tracker
74 Motion analysis means
75 Shape data acquisition means
76 Body shape reproduction means
77 Collision feedback means
78 Vibration reproduction means
81 Robot
82 Marker
84 Control system
85 Motion acquisition means
86 Transmission means
87 Video reproduction means
88 Operation reproduction means
89 Torso type cushion
91 Wide area network
92 Distribution video
95 High-speed network
101 Display
102 Display
103 Shadow spot
105 Virtual display
106 Virtual display
111 Metaverse
112 Network
113 Fusion space
121 Virtual sensor
122 High-speed network
123 Action reproduction device
124 Environment reproduction device
S1, S2 Video signal
U1, U2, U3 User
A Avatar
A1 Operator
RUn Plurality of real mass audience
RU1 Real participant
MUn Plurality of in-world audience
MU1 In-world audience
MAn Plurality of avatars
MA1 Avatar

1. A glasses-free AR display device comprising:
a half mirror disposed upright on a floor;
a darkroom-like structure provided behind the half mirror;
a display disposed in the darkroom-like structure obliquely with respect to a surface of the half mirror;
an illumination located in front of the half mirror and configured to illuminate a user facing toward the display; and
a video controller configured to receive a video signal and cause the display to display a video.

2. The glasses-free AR display device according to claim 1, further comprising:
a camera installed at a position plane-symmetrical to the display with respect to the surface of the half mirror and capturing the user reflected in the half mirror, wherein the video controller acquires a video signal from the camera to transmit it.

3. The glasses-free AR display device according to claim 1, further comprising:
at least a pair of desk-like structures having the same shape disposed in plane symmetry with respect to the surface of the half mirror, wherein
the desk-like structure disposed at the back of the half mirror blocks a view of knees, or a part around a waist or groin of the conversation partner displayed on the display from a visual field of the user.

4. The glasses-free AR display device according to claim 1, further comprising:
a chair-like structure having at least two seats, wherein the chair-like structure is disposed in front of the half mirror such that an alignment direction of the at least two seats is parallel to a surface of the half mirror,
the user sits in one of the seats,
the other seats are vacant seats, and
one of the vacant seats is located in plane symmetry with the display with respect to the surface of the half mirror.

5. The glasses-free AR display device according to claim 1, wherein an antireflection film having a moth-eye structure is stuck on a front surface of the display, a rear surface of the half mirror, or both the front surface and the rear surface.

6. The glasses-free AR display device according to claim 1, further comprising:
a plurality of additional displays, wherein at least one of the plurality of additional displays is disposed in the darkroom-like structure at a position different from the display in a distance from the half mirror, and
at least another one of the plurality of additional displays is disposed behind the user located in front of the half mirror.

7. The glasses-free AR display device according to claim 1, further comprising:
an additional display disposed in the darkroom-like structure in a plane-symmetrical disposition with respect to the surface of the half mirror with respect to a position of the user, and a moving table configured to move the additional display according to change in the position of the user.

8. The glasses-free AR display device according to claim 1, further comprising:
a rotation mechanism configured to rotate the display so that tanΘ=a/2b is maintained when a distance between the user and a conversation partner displayed on the display in a direction parallel to the surface of the half mirror is a, a distance between the surface of the half mirror and the user is b, and an angle between a normal line standing on the surface of the half mirror and a normal line standing on a surface of the display is Θ/2.

9. The glasses-free AR display device according to claim 2, further comprising:
a dark screen or a dark high-back chair having a high backrest, wherein
the dark screen or the backrest of the high-back chair is located at a position plane-symmetrical with the display with respect to the surface of the half mirror,
a hole is formed at the height of eyes of the user in the screen or the backrest, and
the camera is disposed within the hole.

10. The glasses-free AR display device according to claim 1, further comprising:
a dark high-back chair having a high backrest, wherein when an angle formed by a normal line standing on a front surface of the half mirror and a normal line standing on a front surface of the display is Θ/2, the high-back chair is disposed so that a distance from the backrest to the half mirror is equal to a distance from a center of the display to the half mirror and so that the backrest faces the display side at Θ/2 with respect to the normal line standing on the front surface of the half mirror, on a straight line extending from the center of the display at an angle Θ with respect to the normal line standing on the surface of the half mirror.

11. The glasses-free AR display device according to claim 4, further comprising:
a dark cushion disposed on the vacant seat located in plane symmetry with the display with respect to the surface of the half mirror, or a dark robot operating in plane symmetry with respect to a conversation partner displayed on the display.
